SEQUENCE LISTING (31 sequences)

SEQ ID NO: 1 - protein, 11 aa, Artificial Sequence
  Consensus
  X (4)..(5): Any amino acid
  X (8)..(9): Any amino acid
  X (11)..(11): Leucine or other lipophilic amino acid
DRYXXVIXXPX

SEQ ID NO: 2 - DNA, 29 bp, Caenorhabditis elegans
aagctagcaagttgatgtttcacggaacg

SEQ ID NO: 3 - DNA, 29 bp, Caenorhabditis elegans
aggtacccttgtcataattttctttcacc

SEQ ID NO: 4 - DNA, 24 bp, Caenorhabditis elegans
aatggcccgtgcagtcaacatatc

SEQ ID NO: 5 - DNA, 24 bp, Caenorhabditis elegans
gctagacgtcacttgcttcgtgac

SEQ ID NO: 6 - DNA, 20 bp, Globodera pallida
gtgccctaatggtctgtcgg

SEQ ID NO: 7 - DNA, 29 bp, Globodera pallida
cccaagctttgggttcagcatgctatttg

SEQ ID NO: 8 - DNA, 22 bp, Caenorhabditis elegans
tatggattcgttgtttcagatg

SEQ ID NO: 9 - DNA, 21 bp, Caenorhabditis elegans
cacggaaactcaaactacagg

SEQ ID NO: 10 - DNA, 21 bp, Globodera pallida
gtaaaaatggcttccggcatg

SEQ ID NO: 11 - DNA, 21 bp, Globodera pallida
cacttcaattagttgaaatag

SEQ ID NO: 12 - DNA, 25 bp, Caenorhabditis elegans
tatgtcgtacattcttgattggatc

SEQ ID NO: 13 - DNA, 22 bp, Caenorhabditis elegans
ctaaaatgcactggttgcagag

SEQ ID NO: 14 - DNA, 21 bp, Globodera pallida
attaaaatggcccaatggttg

SEQ ID NO: 15 - DNA, 21 bp, Globodera pallida
ttttggaagcgtttgttgtgc

SEQ ID NO: 16 - DNA, 25 bp, Caenorhabditis elegans
atgaagtttattcctgaaatcacac

SEQ ID NO: 17 - DNA, 23 bp, Caenorhabditis elegans
tcactgatagttttgatcgaaac

SEQ ID NO: 18 - DNA, 25 bp, Globodera pallida
atgctttgccccaccggacgtcgtc

SEQ ID NO: 19 - DNA, 25 bp, Globodera pallida
ttagctgaacggaatgattattttc

SEQ ID NO: 20 - protein, 625 aa, Globodera pallida
MAQWLDSFVQKYRSNRRMLLSIVYVALFLDNMLLTTVVPIIPEYLLRLQHPNSTDMLLNNVFSEQELAAPPATPFPPSDKVRVKRQTIGWDSAEWENSLKNDETEQKKPRRFKGKALVAGGMRGGRVRTTMPPPLDMDDDYEALPDEFSIESPIDELDLPSDRSKSMGRRRTSKRPNSTTSSQSSAERQQIAAAAFREVRHRTLTEENVHVGLMFGSKALVQLLANPLVGPLTNKIGYTMPMFAGFVIMFLSTLLFAFGTSFITLWLARSLQGIGSACTSTSGMGMLAQAYPDDAERGSAMGIALGGLALGVLVGPPYGGMLYQWAGKELPFILLALLALLDGSLQFLLLQPKVDRGEPEGTAIKELARDPYIIVAAGSITIGNLGIAMLEPSLPLWMMESWSANSIERGAAFLPASISYLIGTNIFGPLAYKIGRWLSSFIGLIVIGFCLIAIPSASSVFGLILPNFCMGFSIGMIDASMFPMMGHIVDQRHVGVYGSIYAIADAAFCFAFFLGPFFSGPLVRTVGFPTMMYMIAVVNFCYAPLMFFLRVLPAKVPEEQAIVVHADVSSGGRPPLVQRQQSVVRHHLYEKIEGAVDFQLDTGAAATSARNSHYNGYNFSSVWED

SEQ ID NO: 21 - protein, 553 aa, Caenorhabditis elegans
MSYILDWISTYRNNRKILLLIVYIALFLDNMLLTTVVPIIPEYLLRMEHPNETDILFSHNSQKRVKRQWEDDDSWDVPLKLGNNADIDWDENPIGPVGRSERRKESDRKNHNSKNREYNDRRKYMSPAAKKPPVETEEPAVRTISEEERHKLLASENVHVGLMFGSKALVQLLVNPWIGPLTNRIGYTMPMFGGFVIMFCSTILFAFGDSYFTLWLARALQGVGSACTSTSGMGMLAQAYPDDLERGSAMGIALGGLALGVLVGPPYGGLLYQWSGKELPFVLLALLALFDGSIQFMVLQPKIDRGEPEGSSIKQLAKDPYIIVAAGAITIGNLGIAMLEPSLPLWMMESWGANSLERGAAFLPASISYLIGTNIFGPLAHRIGRWLSSFIGLVVIGFSLLSIPSATSVAGLIIPHALLGFSIGMIDASMFPLMGYLVDIRHVGVYGSIYAIADAAFCFAFALGPFFSGPLVKSLGFPTMMYIIAVISFLYAPLMFLLKNPPVLIEPTPQTQSVELRQNGDSRVTNENYERIEGMNIAGQLQQNNMYSATSAF

SEQ ID NO: 22 - protein, 490 aa, Caenorhabditis elegans
MSYILDWISTYRNNRKILLLIVYIDWDENPIGPVGRSERRKESDRKNHNSKNREYNDRRKYMSPAAKKPPVETEEPAVRTISEEERHKLLASENVHVGLMFGSKALVQLLVNPWIGPLTNRIGYTMPMFGGFVIMFCSTILFAFGDSYFTLWLARALQGVGSACTSTSGMGMLAQAYPDDLERGSAMGIALGGLALGVLVGPPYGGLLYQWSGKELPFVLLALLALFDGSIQFMVLQPKIDRGEPEGSSIKQLAKDPYIIVAAGAITIGNLGIAMLEPSLPLWMMESWGANSLERGAAFLPASISYLIGTNIFGPLAHRIGRWLSSFIGLVVIGFSLLSIPSATSVAGLIIPHALLGFSIGMIDASMFPLMGYLVDIRHVGVYGSIYAIADAAFCFAFALGPFFSGPLVKSLGFPTMMYIIAVISFLYAPLMFLLKNPPVLIEPTPQTQSVELRQNGDSRVTNENYERIEGMNIAGQLQQNNMYSATSAF

SEQ ID NO: 23 - protein, 533 aa, Globodera pallida
  misc_feature (223)..(223): Xaa can be any naturally occurring amino acid
MASGMKFLYYNQKTPARRTMSTSMSEHRLEELKQRFRRSGSLGIPFFPEGEDGMELKKELTIAETDESMEEVGSALLTVVVRAQRGIPTLTKTLSTLQRGVQLKHFESRDPKDGQPNELEVLLELELEGGINGNDVLMVLQRAGFLVHELTRTFAPKGAVEPSDPGSADALSGAPWFPKSIYDLDICSKRVIMYGAGLDAEHPGFKDEDYRRRRMMFAELALXSKMGEPIPRVEFTECEKRTWTIIYRKLRELHGKYACQQFLDNFVLLERHCGYSANNIPQLEDVSRFLKAKTGFRVRPVAGYLSARDFLAGLAFRVFNCTQYIRHHADPFYTPEPDTVHELMGHMALFADPDFAQFSQEIGLASLGASEDDLRQLATLYFFSIEFGLCSSETNWGGGTEEVGLSNGRCTARKSDKKSKFKIYGAGLLSSAGELQHAVEGNSEILRFDPDRVVQQECLITTFQTAYFYTRNFEEAQQKLRTFTSNMNRPFVVRYNAYTESVEVLNNKRSLMLAVNSLRSDINLLAASLHNIL

SEQ ID NO: 24 - protein, 532 aa, Caenorhabditis elegans
MDSLFQMASAMKFQYYSKKAAGKTMSNSVSMSSDNRMEDFKRRFRRSGSLGIPFVPEEDVKQLFTPTRTVRREASIREGDEEEGVQILTIIVKSSRVSEDISKMIANLPDHTRIKHLETRDSQDGSSKTMDVLLEIELFHYGKQEAMDLMRLNGLDVHEVSSTIRPTAIKEQYTEPGSDDATTGSEWFPKSIYDLDICAKRVIMYGAGLDADHPGFKDTEYRQRRMMFAELALNYKHGEPIPRTEYTSSERKTWGIIYRKLRELHKKHACKQFLDNFELLERHCGYSENNIPQLEDICKFLKAKTGFRVRPVAGYLSARDFLAGLAYRVFFCTQYVRHHADPFYTPEPDTVHELMGHMALFADPDFAQFSQEIGLASLGASEEDLKKLATLYFFSIEFGLSSDDAADSPVKENGSNHERFKVYGAGLLSSAGELQHAVEGSATIIRFDPDRVVEQECLITTFQSAYFYTRNFEEAQQKLRMFTNNMKRPFIVRYNPYTESVEVLNNSRSIMLAVNSLRSDINLLAGALHYIL

SEQ ID NO: 25 - protein, 429 aa, Caenorhabditis elegans
MIANLPDHTRIKHLETRDSQDGSSKTMDVLLEIELFHYGKQEAMDLMRLNGLDVHEVSSTIRPTAIKEQYTEPGSDDATTGSEWFPKSIYDLDICAKRVIMYGAGLDADHPGFKDTEYRQRRMMFAELALNYKHGEPIPRTEYTSSERKTWGIIYRKLRELHKKHACKQFLDNFELLERHCGYSENNIPQLEDICKFLKAKTGFRVRPVAGYLSARDFLAGLAYRVFFCTQYVRHHADPFYTPEPDTVHELMGHMALFADPDFAQFSQEIGLASLGASEEDLKKLATLYFFSIEFGLSSDDAADSPVKENGSNHERFKVYGAGLLSSAGELQHAVEGSATIIRFDPDRVVEQECLITTFQSAYFYTRNFEEAQQKLRMFTNNMKRPFIVRYNPYTESVEVLNNSRSIMLAVNSLRSDINLLAGALHYIL

SEQ ID NO: 26 - protein, 552 aa, Globodera pallida
MVCRILLLFCIPSSFASSSSSGGPDPSQILERVDHSLFDAWPSTSTPWDTVLSNYSTPSVSTTTAADMAPIRTGPSTSLFHSRPMVALLITALVFVLIVATVLGNLMVCVAIALVRKLKAQPANLLLVSLAVADFCVGLFVMPMAAVYLLEDKWPFGSLLCCFWVTADLTLCTASILNLCMISVDRLLAVTRALRYLAIRTRRRICAVIGAVWVGSLVVSAVPLALVPFRGNGNVCQVSQNRFYQIIATSIAFWVPALIMVIVYVKLWNAAKKMQRQDRMVLRWLGVQCQRQQNTEPTTPKANGTIREMATNNSSPSLLANANARLMTALRPSPTAQQIQRHSIEHNNNNVTAELDKPRPSACSMLAGAIRIPLLGSYSSTASSVVGKSQHIQHEDKARKTLGVMMSVFICCWMPFFILALLKSQRIVYHVPTWLDSLALWLGYSNSMLNPLIYCKYNREFRIPFREMICCRFATLQDAMRNESYYAKFGSPRSRNGRRLNSTASRNWPPTERNDGQKRDGAGGGNGKGRHSLAVGPVTADKRNSTPGALAN

SEQ ID NO: 27 - protein, 435 aa, Caenorhabditis elegans
MARAVNISPFASYTVVPITSAWPPDDLKADRVQLASFTTGKALLAIAILAMIIMTTVGNALVCLAVLLVRKLKHPQNFLLVSLAVADFFVGLVVMPLALIDLLFDKWPLGSTMCSVYTTSDLTLCTASIVNLCAISVDRYLVISSPLRYSAKRTTKRIMMYIACVWIIAAIVSISSHIIANLLNDGTYVDDTGTCQVIPHFIYQSYATIISFYAPTFIMVILNIKIWRAAKRLAAQDRLMSHCNSVDASERPRNGSAETKDFLNEKETIDVPKKERANSTNSRLFKLERKYLHRPSAFFSAAKGPLIRQTEKSECKARKTLGVIMSVFIICWLPFFILAIFKSFGMWIPDWLDLLALWLGYSNSTLNPLIYCKYNKEFRIPFREMLACRCATLQTVMRQQSFTSRYGPPVRYRTQSSSYRPLLSRRNDSHEASDV

SEQ ID NO: 28 - protein, 422 aa, Caenorhabditis elegans
MARAVNISPFASYTVVPITSAWPPDDLKADRVQLASFTTGKALLAIAILAMIIMTTVGNALVCLAVLLVRKLKHPQNFLLVSLAVADFFVGLVVMPLALIDLLFDKWPLGSTMCSVYTTSDLTLCTASIVNLCAISVDRYLVISSPLRYSAKRTTKRIMMYIACVWIIAAIVSISSHIIANLLNDGTYVDDTGTCQVIPHFIYQSYATIISFYAPTFIMVILNIKIWRAAKRLAAQDRLMSHCNSVDASERPRNGSAETKDFLNEKETIDVPKKERANSTNSRLFKLERKYLHRPSAFFSAAKGPLIRQTEKSECKARKTLGVIMSVFIICWLPFFILAIFKSFGMWIPDWLDLLALWLGYSNSTLNPLIYCKYNKEFRIPFREMLACRCATLQTVMRQQSFTSRYGPPVSRRNDSHEASDV

SEQ ID NO: 29 - protein, 410 aa, Caenorhabditis elegans
MARAVNISPFASYTVVPITSAWPPDDLKADRVQLASFTTGKALLAIAILAMIIMTTVGNALVCLAVLLVRKLKHPQNFLLVSLAVADFFVGLVVMPLALIDLLFDKWPLGSTMCSVYTTSDLTLCTASIVNLCAISVDRYLVISSPLRYSAKRTTKRIMMYIACVWIIAAIVSISSHIIANLLNDGTYVDDTGTCQVIPHFIYQSYATIISFYAPTFIMVILNIKIWRAAKRLAAQDRLMSHCNSVDASERPRNGSAETKDFLNEKETIDVPKKERANSTNSRLFKLERKYLHRPSAFFSAAKGPLIRQTEKSECKARKTLGVIMSVFIICWLPFFILAIFKSFGMWIPDWLDLLALWLGYSNSTLNPLIYCKYNKEFRIPFREMLACRCATLQTVMRQQSFTSRYGPPV

SEQ ID NO: 30 - protein, 489 aa, Caenorhabditis elegans
MKFIPEITLLLLLFVHSTQAKGKRRKCPEGAWSEGKIMNTIMSNYTKMLPDAEDSVQVNIEIHVQDMGSLNEISSDFEIDILFTQLWHDSALSFAHLPACKRNITMETRLLPKIWSPNTCMINSKRTTVHASPSENVMVILYENGTVWINHRLSVKSPCNLDLRQFPFDTQTCILIFESYSHNSEEVELHWMEEAVTLMKPIQLPDFDMVHYSTKKETLLYPNGYWDQLQVTFTFKRRYGFYIIQAYVPTYLTIIVSWVSFCMEPKALPARTTVGISSLLALTFQFGNILKNLPRVSYVKAMDVWMLGCISFVFGTMVELAFVCYISRCQNSVRNAERRRERMRNSQVWANGSCRTRSNGYANGGSVISHYHPTSNGNGNNNRHDTPQVTGRGSLHRNGPPSPLNLQMTTFDSEIPLTFDQLPVSMESDRPLIEEMRSTSPPPPSGCLARFHPEAVDKFSIVAFPLAFTMFNLVYWWHYLSQTFDQNYQ

SEQ ID NO: 31 - protein, 639 aa, Globodera pallida
MLCPTGRRRLLLPLLLLLAVHFQLHRKAIARRQKCPGSLSEDKILKEMFRNYTKRLPDSDHKDESVHVEVEMHVQDMGSLNEISADFEIDILFTQLWHDPSLSFVNLSSECVRNITMESRYLKDIWTPNTCIINAKRTSVHASPADNIMFILYENGTIWTNHRLSVKAPCALDLRTFPFDTQTCELLLESYSHNNEEVTLHWMAEPITMMKPIQLPDFDMIQFATKRVSVLYPNGYWDELQARFTFKRRYGFYILQAYVPTYLTIIVSWVAFCMEPKALPARTTVGVSSLLALTLQFGNIHKNLPRVSYVKAMDVWMLGCISFVFGTMIELAVVCYITRRQSMMRSRLARRSSSRGDSLSMYSQHFAHSNRRSFASSCALGDEPPGENTPKKMNYCPEATSFRLLATQRGSRPSSVRLHTLPVRNGTIPSSTNGAQRRRTSNSSNCGGIFPLARRRLKRRSEIDRDVHAGDKSPAIFHPIKQKDGISTTAEVGTGDICIAVPTHTHCAAASPPAQRRAFRSQNGSVPEGIPIDKAQTSAGEERHNNSVDKRSANAIPEEMFPFIPSPMPMPSIGRPLRPSLSSRWRSFGDEEEEEEENRLIIQPESIDKLSIVVFPLTFTLFNVTGRPFHPPKIIIPFS

(19) United States
(12) Patent Application Publication
(10) Pub. No.: US 2021/0360924 A1
(43) Pub. Date: Nov. 25, 2021

(54) PLANT OR SEED COATING

(71) Applicant: University of Southampton, Southampton Hampsire (GB)

(72) Inventors: Lindy Holden-Dye, Southampton Hampshire (GB); Vincent O'Connor, Southampton Hampshire (GB); Peter Urwin, Southampton Hampshire (GB)

(21) Appl. No.: 16/625,580

(22) PCT Filed: Jun. 25, 2018
(86) PCT No.: PCT/GB2018/051770

§ 371 Date: Dec. 20, 2019

(30) Foreign Application Priority Data
Jun. 23, 2017 (GB) 1710057.9

(51) Int. Cl. A01N 43/90; A01N 43/38; A01P 5/00

(52) U.S. Cl. CPC A01N 43/90; A01P 5/00; A01N 43/38

(57) ABSTRACT

A method of inhibiting or preventing damage to plants or seeds by a PPN (Plant Parasitic Nematode). The method comprises applying an effective amount of a biogenic amine signalling pathway inhibitor to a plant or a seed. The biogenic amine signalling pathway inhibitor may be a serotonin signalling pathway inhibitor. In particular, the biogenic amine signalling pathway inhibitor may be reserpine or an active analogue or derivative thereof.

### PRIORITY INFORMATION

This application is a 35 U.S.C. § 371 national phase application of PCT Application PCT/GB2018/051770, filed on Jun. 25, 2018, which claims the benefit of Provisional Application Serial No. GB 1710057.9, filed Jun. 23, 2017, the entire contents of each of which are incorporated by reference herein.

### FIELD OF THE INVENTION

The present invention relates to the use of a seed coating, in particular to deter nematodes from damaging plants. The present invention further relates to a seed having a coating.

### BACKGROUND TO THE INVENTION

Plant parasitic nematodes (PPNs) are nematode worms that invade the roots of their host plants impairing plant viability, reducing the yield of crops and threatening food security. They have a significant severe global economic impact as most major food crops are susceptible to infestation by at least one nematode species and PPNs are estimated to cause $125 billion of damage to crops per annum.

The most damaging and widespread of all PPNs are sedentary endoparasites that include the root knot nematodes, Meloidogyne spp. and the cyst nematodes such as Globodera spp. Root knot nematodes and cyst nematodes hatch at the 2nd juvenile stage outside of a host plant. On locating a suitable host the juveniles invade the root

by piercing it using their stylet which is a lance-like organ that protrudes from the mouth of the PPN and which is used to pierce the host plant root to gain access. The stylet acts in a thrusting motion to pierce the root and this thrusting motion is called stylet thrusting. After gaining access to the plant, the PPN finds an appropriate location to establish a feeding site, where they will develop through to adulthood and reproduce.

Despite their economic importance, much remains unknown about these sedentary endoparasitic nematodes, including the neural mechanisms underlying the behaviours that allow host plant location and invasion that are essential to the parasitic life cycle.

The main method currently used to reduce the damage caused by PPNs is the use of agricultural chemicals applied to the soil and or to crops. These chemicals are typically either nematostatics which paralyse the worms by interfering with cholinergic transmission or metabolic poisons. However, the off-target toxicity of these agents is increasingly considered unacceptable and they are being removed from use (e.g. EU regulation EC

1107/2009). This presents a growing economic burden that demands new approaches to crop protection.

It would be advantageous to be able to interfere with the infectivity of PPNs by selectively and discretely disabling behaviours that are intrinsic to their parasitic life cycle. This approach would be less likely to have off-target effects on other creatures, humans or the environment.

It is clear that the stylet thrusting behaviour is essential for plant parasitism and yet relatively little is known about the molecular and physiological mechanisms that underpin its activity.

Serotonin signalling plays an important role in the parasitic life cycle of a PPN and in particular that serotonin signalling controls stylet pumping and therefore invasion of host plants by PPNs. Where the serotonin pathway is blocked the inventors have found that the PPNs are unable to penetrate into the plant, therefore breaking the life cycle of the PPN as they are unable to reproduce.

The present inventors have shown that a naturally occurring alkaloid, reserpine, which acts on the serotonin signalling pathway, inhibits stylet thrusting in PPNs and prevents them from breaking through into the roots of plants.

Inhibitors of the serotonin signalling pathway, such as reserpine are advantageous agents for preventing crop damage by PPNs because they specifically block stylet thrusting and hence break the life cycle of PPNs. As stylet thrusting is very specific to the life cycle of PPNs inhibitors of the serotonin signalling pathway are less likely to have off-target effects. Reserpine is a natural product that occurs in the shrub Rauvolfia serpentina, common name Indian Snake Root, which has been used in herbal medicine for centuries. This makes it very attractive for use as a pesticide with current concerns about over-use of artificial chemicals in agriculture and food production and worries about artificial chemicals damaging human health and the environment.

Accordingly, it is advantageous to use inhibitors of the serotonin signalling pathway, such as reserpine to prevent or reduce damage to plants, seeds or seedlings by PPNs.

### SUMMARY OF THE INVENTION

According to a first aspect the present invention provides a method of inhibiting or preventing damage to plants or seeds by a PPN (Plant Parasitic Nematode) the method comprising: applying an effective amount of a biogenic amine signalling pathway inhibitor to plants or seeds.

A biogenic amine is a biogenic substance (i.e. produced by life processes) with one or more amine groups. The biogenic amine signalling pathway inhibitor may inhibit a monoamine neurotransmitter, such as serotonin (5-HT), dopamine, octopamine and/or tyramine.

In one such embodiment, there is provided a method of inhibiting or preventing damage to plants or seeds by a PPN (Plant Parasitic Nematode) the method comprising: applying an effective amount of a serotonin signalling pathway inhibitor to plants or seeds.

The biogenic amine signalling pathway (e.g. serotonin signalling pathway inhibitor) may be a compound or composition that inhibits or prevents stylet thrusting in the PPN and therefore prevents it from piercing the plant to enter it. For example inhibiting stylet thrusting may prevent the PPN from piercing the root or a stem of a plant.

The PPN may be any Plant Parasitic Nematode, for example a sedentary endoparasite. The PPN may be a root knot nematode, such as a Meloidogyne spp nematode. The PPN may be a cyst nematode, such as Globodera spp nematode. The PPN may be a migratory ectoparasitic nematode which also requires use of the stylet to feed externally on the plant; this includes stubby root (Paratrichodorus and Trichodorus), dagger (Xiphinema), needle (Longidorus, Paralongidorus), ring (Criconemella, Macroposthhonia), stunt (Tylenchorhynchus and Merlinius), pin (Paratylenchus), and spiral (Helicotylenchus, Rotylenchus, and Scutellonema) nematodes.

The biogenic amine signalling pathway (e.g. serotonin signalling pathway inhibitor) may be any inhibitor of an enzyme or transduction molecule required for biogenic amine signalling (e.g. serotonin signalling) in one or more PPNs. The biogenic amine signalling pathway inhibitor (e.g. serotonin signalling pathway inhibitor) may prevent or significantly reduce stylet thrusting in PPNs. Or it may inappropriately activate the stylet when the nematode is not in the proximity of the host root. The biogenic amine signalling pathway inhibitor (e.g. serotonin signalling pathway inhibitor) may prevent or significantly reduce the PPN's ability to pierce a plant with the stylet by preventing or reducing stylet thrusting or inappropriately activating it when the nematode is not in the proximity of the host plant root.

The biogenic amine signalling pathway (e.g. serotonin signalling pathway inhibitor) may be a modulator of the activity of the vesicular monoamine transporter (VMAT) or the MOD-1 receptor. The biogenic amine signalling pathway (e.g. serotonin signalling pathway inhibitor) may be a VMAT or MOD-1 antagonist or a VMAT or MOD-1 agonist.

The biogenic amine signalling pathway (e.g. serotonin signalling pathway inhibitor) may be VMAT modulator. VMAT may be VMAT-1 or VMAT-2. VMAT-1 is also known as chromaffin granule amine transporter (CGAT) or solute carrier family 18 member 1 (SLC18A1) is a protein that in humans is encoded by the SLC18A1 gene. VMAT2 is also known as solute carrier family 18 member 2 (SLC18A2) is a protein that in humans is encoded by the SLC18A2 gene.

VMAT inhibitors include: reserpine (RES), bietaserpine, and ketanserin (KET) (potent inhibitors of VMAT2 mediated serotonin transport); Tetrabenazine (TBZ) (specific to VMAT2); phenylethylamine; amphetamine; MDMA; N-methyl-4-phenylpyridinium (MPP+)(very potent inhibitors of VMAT2 mediated serotonin transport); fenfluramine (specific to VMAT1); and non-hydrolysable GTP-analogue guanylyllimidodiphosphate GMP-P(NH)P (VMAT2 only).

The plant may be a plant at any stage of development or a seed. The plant may be a germinating or germinated seed. The plant may be a seedling.

An effective amount of the biogenic amine signalling pathway (e.g. serotonin signalling pathway inhibitor) is an amount that is able to reduce or prevent stylet thrusting in a PPN enough to prevent the PPN from entering the plant or to significantly reduce the ability of PPNs to enter pierce and enter a plant.

The skilled person may determine an effective amount of the biogenic amine signalling pathway inhibitor (e.g. serotonin signalling pathway inhibitor) by any standard method. For example, by applying the biogenic amine signalling pathway inhibitor (e.g. serotonin signalling inhibitor) to a plant or seed in the desired way and testing whether the target PPN can enter the plant. Alternatively the skilled person may apply the biogenic amine signalling pathway inhibitor (e.g. serotonin signalling pathway inhibitor) as a seed coating and determine the concentration that prevents PPNs from entering the plants that germinate from the seed. An effective amount of reserpine for use as a seed coating may be 30-340 micrograms per seed. The amount of reserpine may be enough that, as the seed germinates, the reserpine is incorporated into the developing seedling and the concentration of reserpine in the seedling is enough to prevent PPNs from entering the seedling while it is at a stage where it is vulnerable to invasion by PPNs. As the plant grows the roots become stronger and PPNs are no longer able to penetrate them.

Where the biogenic amine signalling pathway inhibitor (e.g. serotonin signalling pathway inhibitor) is applied as a seed coating, an effective amount may be an amount that is able to reduce or prevent stylet thrusting in a PPN and/or reduce and prevent a PPN from piercing and/or entering a plant that results from germination of the seed.

An effective amount of the biogenic amine signalling pathway inhibitor (e.g. serotonin signalling pathway inhibitor) in a seed coating may be an amount that results in the concentration in the resulting plant being high enough to prevent a PPN from piercing and/or entering the resulting plant. This may mean that the concentration of the biogenic amine signalling pathway inhibitor (e.g. serotonin signalling pathway inhibitor) is high enough in the plant just after it has germinated from a seed when it is most susceptible to attack by PPNs.

The biogenic amine signalling pathway inhibitor (e.g. serotonin signalling pathway inhibitor) may be formulated in a solid composition or liquid composition. The biogenic amine signalling pathway inhibitor (e.g. serotonin signalling pathway inhibitor) may be formulated in a seed coating composition or a liquid composition for spraying on plants or solid composition, such as granules or powder, for sprinkling or dusting on plants or as a gel.

The biogenic amine signalling pathway inhibitor (e.g. serotonin signalling pathway inhibitor) may be formulated in a composition comprising further active or inactive ingredients or carriers, for example known pesticides, fungicides, herbicides, fertilisers or other products to aid plant growth.

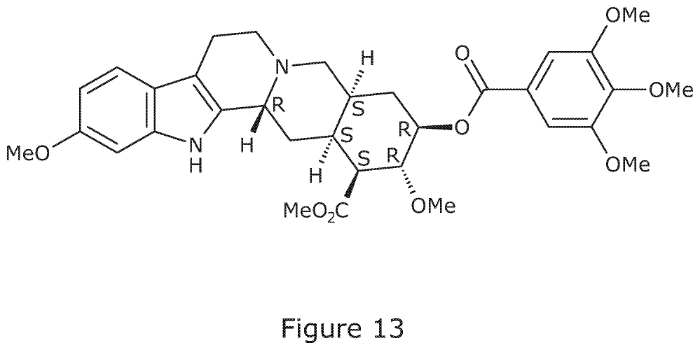

The biogenic amine signalling pathway inhibitor (e.g. serotonin signalling pathway inhibitor) may be reserpine or an active analogue or derivative thereof. Reserpine has the structure shown in FIG. 13.

An active analogue or derivative of reserpine may be a compound that has a similar structure to reserpine and a similar activity to reserpine. An active analogue or derivative of reserpine may be able to prevent stylet thrusting in a PPN in a similar or the same way as reserpine. An active analogue or derivative of reserpine may be able to prevent stylet thrusting in PPN at the same or a similar dose to reserpine or at a lower dose.

Reserpine or an active analogue or derivative thereof may include a compound having the general structure:

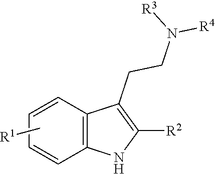

Each of R¹ to R³ is independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl (such as phenyl). In particular each of R¹ to R³ may be independently selected from H, C₁₋₃ alkyl, O(C₁₋₃ alkyl), CH₂O(C₁₋₃ alkyl), CO₂(C₁₋₄ alkyl), and C₆₋₁₀ aryl (such as phenyl).

R¹ represents the substituents on the ring and may comprise one or more non-hydrogen substituents. Preferably, R¹ comprises one or more hydroxyl or O(C₁₋₃ alkyl) groups. Most preferably, R¹ is one or more methoxy groups, particularly in the 6-position of the indole ring.

In each embodiment of the present invention, alkyl, alkenyl and/or aryl, such as phenyl, may be unsubstituted or may be substituted with one or more group selected from halogen, OH, O(C₁₋₄ alkyl) (such as methoxy), OC(O)C₁₋₄ alkyl, C(O)OC₁₋₄ alkyl, and C₁₋₄ alkyl.

In each embodiment of the present invention, halogen includes fluorine, chlorine, bromine and iodine groups.

In each embodiment of the present invention, alkyl and alkenyl include branched and straight-chain alkyl/alkenyl groups.

R⁴ may comprise 30 carbons or less, such as 25 carbons or less. R⁴ comprises one or more groups selected from H, C₁₋₄ alkyl, OH, halogen, O(C₁₋₄ alkyl), C₂₋₄ alkenyl, OCO₂(C₁₋₄alkyl), NHCO₂(C₁₋₄alkyl), NHCO(C₁₋₄alkyl), O(C₁₋₄ alkyl), OC(O)C₁₋₄ alkyl, C(O)OC₁₋₄ alkyl, OC(O)C₆₋₁₀ aryl, C(O)OC₆₋₁₀ aryl, CH₂O(C₁₋₄ alkyl), and C₆₋₁₀ aryl (such as phenyl). Preferably, R⁴ may comprise one or more groups selected from H, C₁₋₄ alkyl, O(C₁₋₄ alkyl), OC(O)C₁₋₄ alkyl, C(O)OC₁₋₄ alkyl, CH₂O(C₁₋₄ alkyl), OC(O)-phenyl, C(O)O-phenyl, and C₆₋₁₀ aryl (such as phenyl).

R³ and R⁴ may form a heterocycloalkyl group, such as a 5 to 8 membered heterocycloalkyl group. In one such embodiment reserpine or an active analogue or derivative thereof has the following general structure:

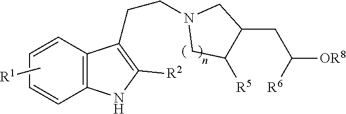

R¹ and R² are as described above.
n may be 1 to 4 (yielding a 5 to 8 membered ring). Preferably, n is 2 (yielding a 6 membered ring).

Each of R⁵ and R⁶ are independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl (such as phenyl). In particular each of R⁵ and R⁶ may be independently selected from H, C₁₋₃ alkyl, O(C₁₋₃ alkyl), CH₂O(C₁₋₃ alkyl), CO₂(C₁₋₄ alkyl), and C₆₋₁₀ aryl (such as phenyl).

R⁸ is selected from H, C₁₋₆ alkyl, C₂₋₆ alkenyl, CO₂(C₁₋₆alkyl), C(O)C₁₋₆ alkyl, C(O)C₆₋₁₀ aryl, CO₂C₆₋₁₀ aryl, CH₂O(C₁₋₄ alkyl), and C₆₋₁₀ aryl (such as phenyl). Preferably, R⁸ is C(O)C₆₋₁₀ aryl, more preferably C(O) phenyl, and yet more preferably C(O) phenyl substituted with methoxy groups in the 3, 4 and 5 positions.

R⁵ and R⁶ may link together through a C₁₋₄ alkyl group to form a 5 to 8 membered cycloalkyl or heterocycloalkyl group, e.g. a 6 membered cycloalkyl group.

R² can be considered to form a 6 membered heterocycloalkyl group with R³ or R⁴. R² together with R³ and R⁴ may form the fused pentacyclic ring structure of reserpine. In one such embodiment reserpine or its active analogue or derivative thereof has the following general structure

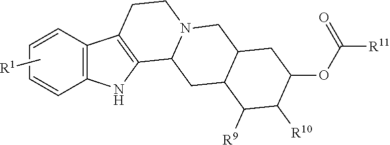

R¹ is as described above.

Each of R⁹ to R¹¹ may be independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl (such as phenyl). In particular each of R⁹ to R¹¹ may be independently selected from H, C₁₋₃ alkyl, O(C₁₋₃ alkyl), CH₂O(C₁₋₃ alkyl), CO₂(C₁₋₄ alkyl), and C₆₋₁₀ aryl (such as phenyl).

R⁹ may preferably be C(O)O— C₁₋₄ alkyl, such as CO₂CH₃. R¹⁰ may be O(C₁₋₄ alkyl), such as OCH₃ (methoxy). R¹¹ may be unsubstituted phenyl or phenyl substituted with C₁₋₄ alkyl or C₁₋₄ alkoxy. Preferably, R¹¹ is phenyl substituted with methoxy groups in the 3, 4 and 5 positions.

Reserpine, its active analogue or derivative thereof may have the following general structure, wherein R¹³, R¹⁴ and R¹⁵ are respectively in the 3, 4 and 5 positions of the phenyl ring.

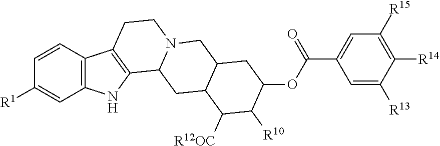

R¹ is as described above. Preferably, R¹ represents a non-hydrogen substituent (e.g. O(C₁₋₄ alkyl), such as methoxy) at the position indicated.

R¹⁰ is as described above.

R¹² is selected from C₁₋₄ alkyl, C₂₋₄ alkenyl, and C₆₋₁₀ aryl (such as phenyl). Preferably, R² is C₁₋₄ alkyl, such as methoxy.

Each of R¹³, R¹⁴ and R¹⁵ may be independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl (such as phenyl). In particular, each of R¹³, R¹⁴ and R¹⁵ may be independently selected from H, C₁₋₃ alkyl, O(C₁₋₃ alkyl), and CH₂O(C₁₋₃ alkyl). Preferably, each of R¹³, R¹⁴ and R¹⁵ is O(C₁₋₃ alkyl), more preferably methoxy.

Reserpine, its active analogue or derivative thereof may have the following general structure

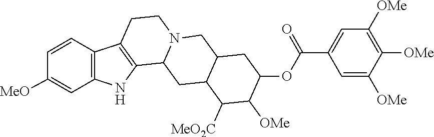 [SMILES: COC(=O)C1C2CC3c4[nH]c5cc(OC)ccc5c4CCN3CC2CC(OC(=O)c2cc(OC)c(OC)c(OC)c2)C1OC]

Reserpine is a specific isomer of this compound as shown in FIG. 13.

Advantageously an active analogue or derivative of reserpine may be a compound that has similar structure and activity to reserpine but has increased selectivity for the PPN enzyme compared to the mammalian enzyme.

A composition comprising reserpine may be a composition comprising a chemically synthesised reserpine or reserpine extracted from a natural source. A composition comprising reserpine may comprise Indian Snake Root Rauvolfia serpentina or extracts thereof that comprise reserpine.

The method of the present invention may comprise the step of applying a composition comprising an effective amount of reserpine to a plant or seed wherein the reserpine is effective to prevent or reduce stylet thrusting in a PPN and/or is effective to prevent piercing of the plant by a PPN.

The method of the present invention may comprise the step of applying a composition comprising an effective amount of reserpine to a seed as a seed coating wherein the reserpine is effective to prevent or reduce stylet thrusting in a PPN and/or is effective to prevent or reduce piercing of a plant resulting from the seed by a PPN.

The serotonin signalling pathway inhibitor may be tetrabenazine analogues, ketanserin analogs, lobeline analogs, and 3-amine-2-phenylpropene analogs as described by Zheng et al (The AAPS Journal 2006; 8 (4) Article 78).

The serotonin signalling pathway inhibitor may be tetrabenazine (TBZ) or an analogue or derivative thereof, such as a compound of the following general structure:

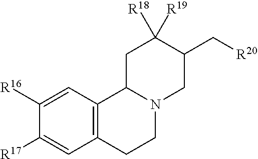

Each of R¹⁶, R¹⁷ and R²⁰ may be independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl (such as phenyl). In particular each of R⁹ to R¹¹ may be independently selected from H, C₁₋₃ alkyl, O(C₁₋₃ alkyl), CH₂O(C₁₋₃ alkyl), CO₂(C₁₋₄ alkyl), and C₆₋₁₀ aryl (such as phenyl).

Each of R¹⁸ and/or R¹⁹ may double bond O, H, OH, OR^{x}, NR^{x}, SR^{x} (R^{x}=C₁₋₁₂ alkyl, C₂₋₁₂ alkenyl, C₂₋₁₂ alkynyl or C₅₋₁₂ aryl, optionally including one or more groups selected from hydroxyl, amine, amide, ester, azide, and halogen groups).

In TBZ each of R¹⁶ and R¹⁷ is methoxy; R¹⁸ and R¹⁹ together form double bond O; and R²⁰ is isopropyl.

The serotonin signalling pathway inhibitor may be ketanserin (CAS 74050-98-9), or an analogue or derivative thereof.

The serotonin signalling pathway inhibitor may be lobeline or an analogue or derivative thereof, such as lobelane, norlobelane and quinlobelane. Such compounds are described by Ding et al (Bioorganic & Medicinal Chemistry Letters 25 (2015) 2613-2616).

In a second aspect the present invention provides the use of an effective amount of a biogenic amine signalling pathway inhibitor (e.g. serotonin signalling pathway inhibitor) to prevent damage to plants by PPNs.

The serotonin signalling pathway inhibitor may be reserpine or an active analogue or derivative thereof.

In a further aspect the present invention provides a use of a composition comprising a biogenic amine signalling pathway inhibitor (e.g. serotonin signalling pathway inhibitor) as a pesticide or seed coating. The serotonin signalling pathway inhibitor) may be reserpine or an active analogue or derivative thereof.

In a further aspect the present invention provides a seed coated with a composition comprising a biogenic amine signalling pathway inhibitor (e.g. a serotonin signalling pathway inhibitor). The serotonin signalling pathway inhibitor may be reserpine or an active analogue or derivative thereof.

In a further aspect the present invention provides a plant or seed that is genetically modified to produce a biogenic amine signalling pathway inhibitor (e.g. a serotonin signalling pathway inhibitor). The plant or seed may be a plant or seed that is genetically modified to produce reserpine in one or more tissues.

The method or product of the invention may further comprise any one or more features of the embodiments of the invention which are shown by way of example only in the accompanying drawings as will now be described.

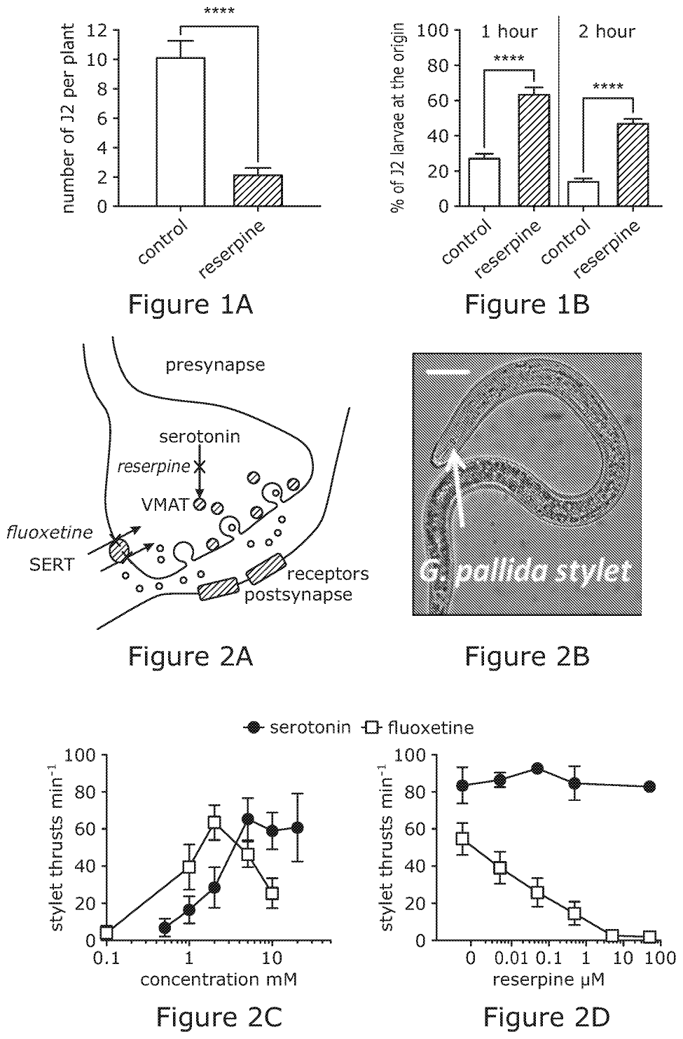

FIG. 1 shows the results of an experiment investigating whether reserpine inhibits G. pallida host plant invasion behaviour.

A. J2s were collected at 24 h post hatching and pre-incubated with 24 h in water without (control), or with the addition of reserpine (100 μM). J2s were applied to individual potato hairy root cultures at 3 infection points with 25 J2s per infection point. 13 days later roots were fuschin stained and visualised for J2. Date are mean±s.e.m. for 20 plants; **** p<0.0001 unpaired Student's t-test. B. The effect of reserpine on J2 motility was tested in a dispersal assay in which their ability to move away from the central point of an agar arena was determined. For each assay about 50 to 100 J2s were presoaked in water (control), or water with 50 μM reserpine for 18 h. They were then pipetted onto the centre of the plate in a minimum (˜5 μL) volume of liquid. The percentage of J2s remaining at the origin was determined after 1 and 2 h. Data re mean±s.e.m. of 4 plates for each experimental group. One way ANOVA with Bonferroni's multiple comparisons; ****p<0.001.

FIG. 2 shows the results of an experiment investigating whether reserpine inhibits stylet thrusting triggered by endogenous, but not exogenous, serotonin. A. The cartoon depicts a serotonergic synapse, with the presynapse as the site of serotonin synthesis and release and the postsynapse which harbours serotonin receptors. Reserpine acts presynaptically to deplete the storage of the neurotransmitter in serotonin by preventing its uptake into vesicles (shown as red circles) by a potent and selective inhibition of the vesicular monoamine transporter, VMAT. This results in a lack of serotonin presynaptically and a block of serotonergic neurotransmission. Fluoxetine (Prozac®) blocks the plasma membrane serotonin transporter, SERT. Thus it increases synaptic levels of serotonin (shown by open red circles) by preventing its reuptake into the presynaptic terminal following its release. In this way fluoxetine can act indirectly to stimulate transmission at the serotonergic synapse. This effect of fluoxetine is blocked by reserpine as it requires endogenous serotonin to elicit its effect. However, reserpine does not block the response to exogenous serotonin which acts directly on the postsynaptic receptors. B. The G. pallida stylet is a lance-like structure that can be thrust out of the mouth of the worm (in this image it is shown in the retracted position) in a rhythmic manner to initiate hatching and root invasion. Inside the root it is used for migration and to support feeding and interaction with the host. The activity of the stylet can be visually scored by counting the number of thrusts made in 1 min. Scale bar ˜20 μm. C. J2s were incubated in either serotonin or fluoxetine at the concentrations indicated for 1 h and then the number of stylet thrusts made in 1 min was counted. Data are mean±s.e.m.; n=8 to 17 for each time point. D. Reserpine blocks the stylet response to fluoxetine but not serotonin. J2s were presoaked in reserpine at the concentration indicated for 24 h and subsequently immersed in either 10 mM serotonin or 2 mM fluoxetine for 30 min and stylet thrusting scored for 1 min. Data are mean±s.e.m.; n=10 J2s for each data point.

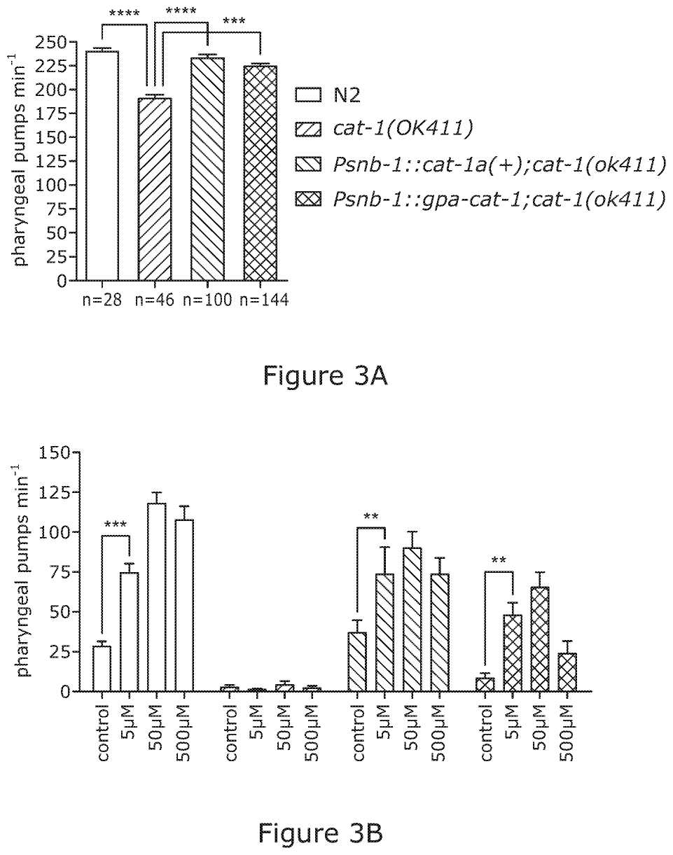

FIG. 3. shows the results of an experiment demonstrating functional characterisation of a gene encoding G. pallida VMAT, gpa-cat-1. A. Expression of G. pallida cat-1 (gpa-cat-1) rescues the pharyngeal phenotype of C. elegans cat-1 (ok411). A comparison of the pumping rate on food for N2, cat-1 (ok411) and transgenic lines of cat-1 (ok411) expressing either wild type C. elegans cat-1, cat-1 (+) or gpa-cat-1 behind a pan-neuronal promoter (Psnb-1). Four stable lines for each transgenic strain were tested and the data are pooled for presentation. Data are mean±s.e.m; ‘n’ is shown in brackets. *** p<0.001; **** p<0.0001; One way ANOVA with Bonferroni's multiple comparisons. B. Expression of gpa-cat-1 in C. elegans cat-1 (ok411) reinstates sensitivity to fluoxetine. One day old hermaphrodite C. elegans were placed on agar plates that either had no drug, ‘control’, or had been prepared with fluoxetine (5 to 500 μM). After 1 h the rate of pharyngeal pumping was scored in each worm for 1 min. N2 wild type worms pumped at a low rate which increased in a concentration-dependent manner in the presence of fluoxetine. Fluoxetine did not stimulate pumping in cat-1 (ok411) but the response was restored in the transgenic worms expressing either cat-1(+) or gpa-cat-1 behind a pan-neuronal promoter (psnb-1). Two stable lines for each transgenic strain were tested and the data are pooled. Data are the mean±s.e.m.; n≥17; **p<0.01; *** p<0.001; Two way ANOVA with Bonferroni's multiple comparisons. For the sake of clarity only one comparison is shown for each strain between control and 5 μM fluoxetine.

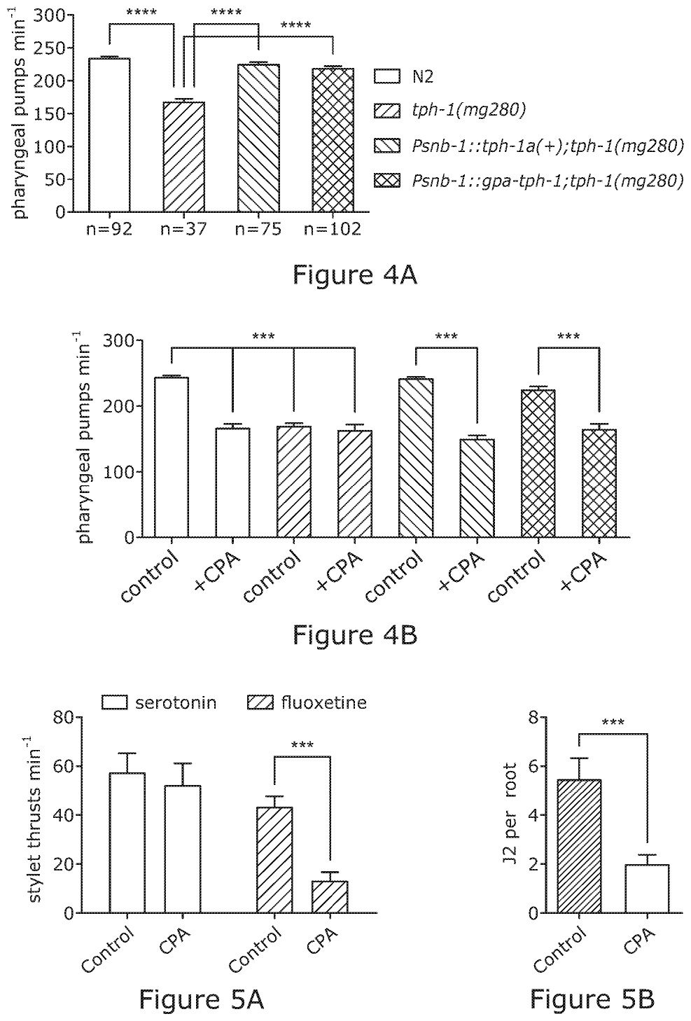

FIG. 4 shows the results of an experiment demonstrating functional characterisation of a gene encoding G. pallida tryptophan hydroxylase, gpa-tph-1. A. Expression of gpa-tph-1 rescued the pharyngeal phenotype of C. elegans tph-1 (mg280) similar to expression of a wild type copy of C. elegans tph-1, tph-1(+). Both genes were expressed from the pan-neuronal promoter Psnb-1. Pharyngeal pumping rate of one day old adult hermaphrodites on food was scored for 1 min for each worm. Four stable lines for each transgenic strain were tested and the data are pooled. Data are mean±s.e.m; ‘n’ is indicated on the graph; **** p<0.0001; one way ANOVA with Bonferroni's multiple comparisons. B. Expression of either C. elegans tph-1(+) or gpa-tph-1 in the C. elegans mutant tph-1 (mg280) conferred sensitivity to the tryptophan hydroxylase inhibitor, CPA. One day old adult hermaphrodites were incubated for 2 h on agar plates with food and without, (control), or with 1 mM CPA. Two stable lines were tested for each transgenic strain and the data are pooled. Data are the mean±SEM of n≥10; ***p<0.001; one way ANOVA with Bonferroni's multiple comparisons.

FIG. 5 shows the results of an experiment investigating the role of TPH-1 in host plant invasion behaviour. A. G. pallida J2s were soaked in either water (control) or water with the TPH inhibitor CPA (100 μM) for 24 h. This was followed by the addition of either serotonin (10 mM) or fluoxetine (2 mM) for 30 min and stylet thrusting was scored for 1 min. Data are mean±s.e.m. n=27 for serotonin and n=40 for fluoxetine. *** p<0.001; Two way ANOVA with Bonferroni's multiple comparisons. B. CPA impairs the ability of J2s in root invasion. J2s were collected at 24 h post hatching and pre-incubated with 24 h in water without (control), or with the addition of CPA (100 μM). J2s were applied to individual potato hairy root cultures at 3 infection points with 25 J2s per infection point. 13 days later roots were fuschin stained and visualised for J2. Data are mean±s.e.m. for 19 plants; **** p<0.001 unpaired Student's t-test.

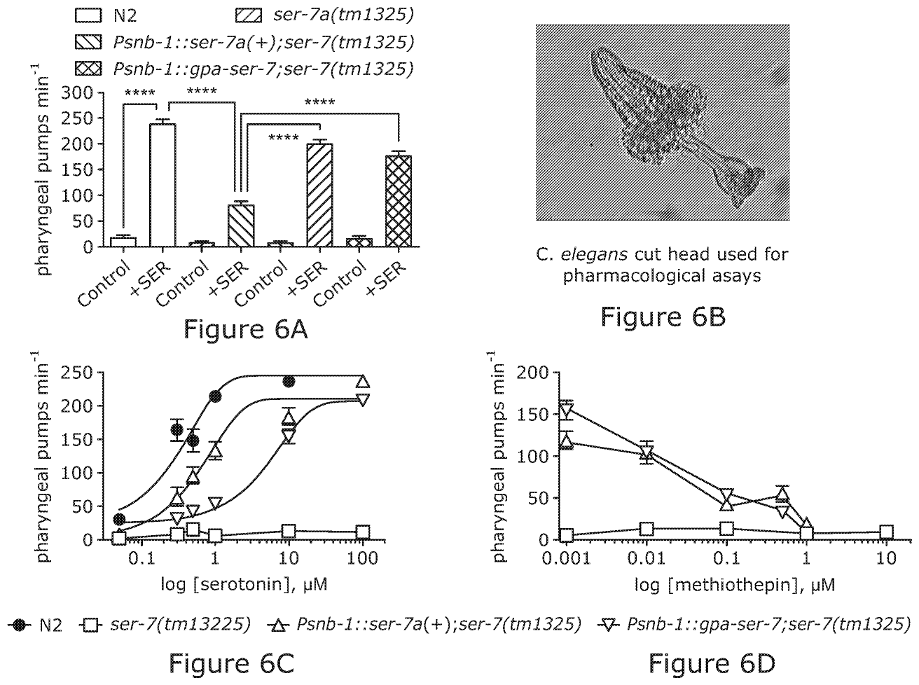

FIG. 6 shows the results of an experiment showing characterisation of G. pallida SER-7 A. Expression of gpa-ser-7 rescued the pharyngeal phenotype of C. elegans ser-7 (tm1325) similar to expression of a wild type copy of C. elegans ser-7a, ser-7a(+). Both genes were expressed from the pan-neuronal promoter Psnb-1. Pharyngeal pumping rate of one day old adult hermaphrodites after 20 min off food was scored for 1 min for each worm either in the absence (control) or presence (SER) of 10 mM serotonin. Three stable lines for each transgenic strain were tested and the data are pooled. Data are mean±s.e.m; n≥20; **** p<0.0001; one way ANOVA with Bonferroni's multiple comparisons. Note that the whilst the pumping rate of ser-7 (tm1325) is increased by 10 mM 5-HT this response is significantly lower than that for wild type and both transgenic strains. B. An image of the cut head preparation that was used for the experiments shown in C and D. Cutting the head exposes the pharynx to the external solution allowing ready access of applied drugs to the receptors regulating the pharyngeal network. Pharyngeal pumps were recorded visually by counting the contraction-relaxation cycles of the terminal bulb. Scale bar ˜25 sm. C. Concentration-response of the pumping rate of the cut head pharyngeal preparations to serotonin for wild type (N2), ser-7 (tm1325) and transgenic lines of ser-7 (tm1325) expressing either C. elegans or G. pallida ser-7 behind a pan-neuronal promoter (psnb-1). Note that in the dissected pharyngeal preparation ser-7 (tm1325) mutants do not respond to even 100 μM serotonin. Data are the mean±s.e.m.; n≥20. D. Methiothepin blocked the response to serotonin in both transgenic strains. Cut heads were pre-incubated with methiothepin at the concentrations indicated for 5 min after which 100 μM serotonin was added and after a further 10 min the pumping rate was scored for 1 min. Two stable lines for each transgenic strain were tested and the data are pooled. Data are the mean±s.e.m; n≥5.

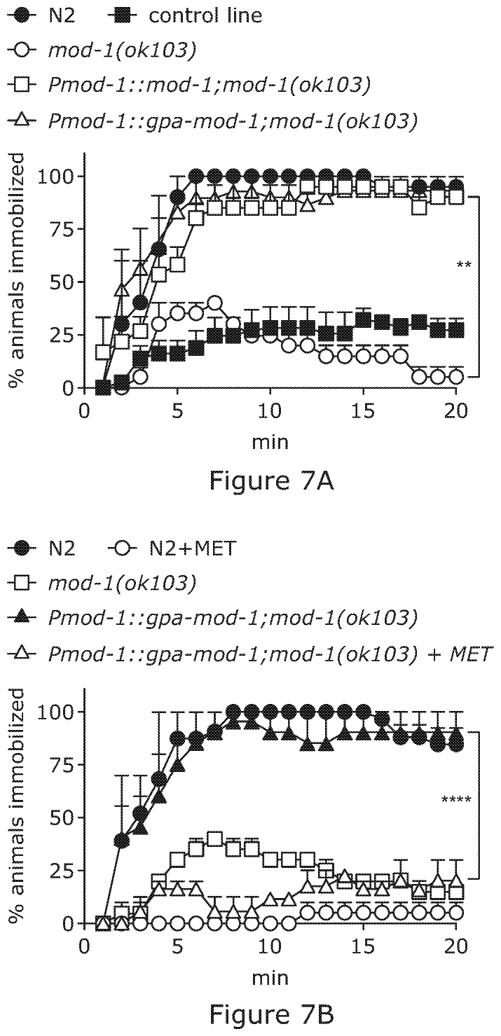

FIG. 7 shows the results of an experiment showing characterisation of G. pallida MOD-1. A. Expression of gpa-mod-1 rescued the motility phenotype of C. elegans mod-1 (ok103) similar to expression of a wild type copy of C. elegans mod-1, mod-1(+). Both genes were expressed from the putative native mod-1 promoter, Pmod-1. Approximately 10 one day old adult hermaphrodite C. elegans were dispensed into each well of a 24 well plate. At time 0, 33 mM serotonin was added to each well and the percentage of immobilised worms in each well was scored every min for up to 20 min. Stable lines for each transgenic strain were tested and the data are pooled. Data are mean±s.e.m; n=3; ** p<0.01; two way ANOVA with Bonferroni's multiple comparisons. B. The serotonin-induced paralysis is blocked by methiothepin in both wild type (N2) and in the transgenic strain expressing gpa-mod-1 in mod-1 (ok103). The experiment was performed as in A with the addition of a preincubation in 10 μM methiothepin for X min. Data are mean±s.e.m; n=2?; ** p<0.01; two way ANOVA with Bonferroni's multiple comparisons.

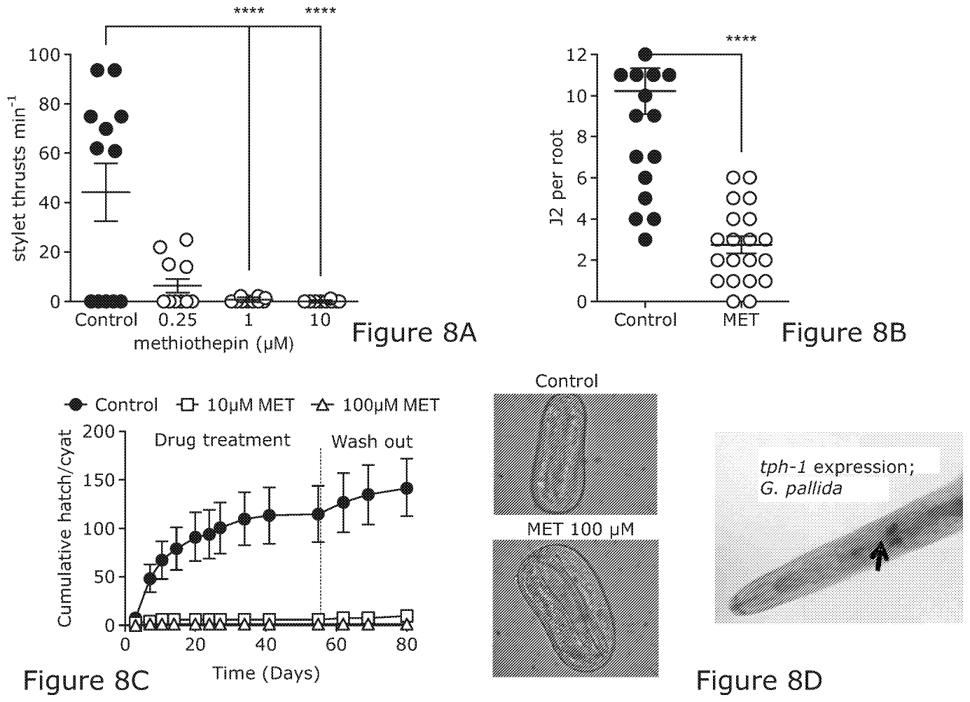

FIG. 8 shows the results of an experiment investigating whether methiothepin is a potent inhibitor of G. pallida behaviours underpinned by stylet thrusting. A. G. pallida J2s were soaked in either a control solution of 0.5% ethanol or methiothepin at different concentrations for 24 h. They were transferred to 2 mM fluoxetine and the rate of stylet thrusting was counted for 1 min after 30 min had elapsed. Data are mean±s.e.m.; n=12; p<0.0001; one-way ANOVA with Bonferroni's multiple comparisons. B. Methiothepin (MET) impairs the ability of J2s to invade the host root. J2s were collected at 24 h post hatch and pre-incubated for 24 h in water without (control), or with the addition of MET (100 μM). J2s were applied to individual potato hairy root cultures at 3 infection points with 25 J2s per infection point. 13 days later roots were fuschin stained and visualised for J2. Data are mean±s.e.m. for 20 plants for control and 21 plants for MET; **** p<0.001 unpaired Student's t-test. C. MET blocks hatching of J2s from cysts.

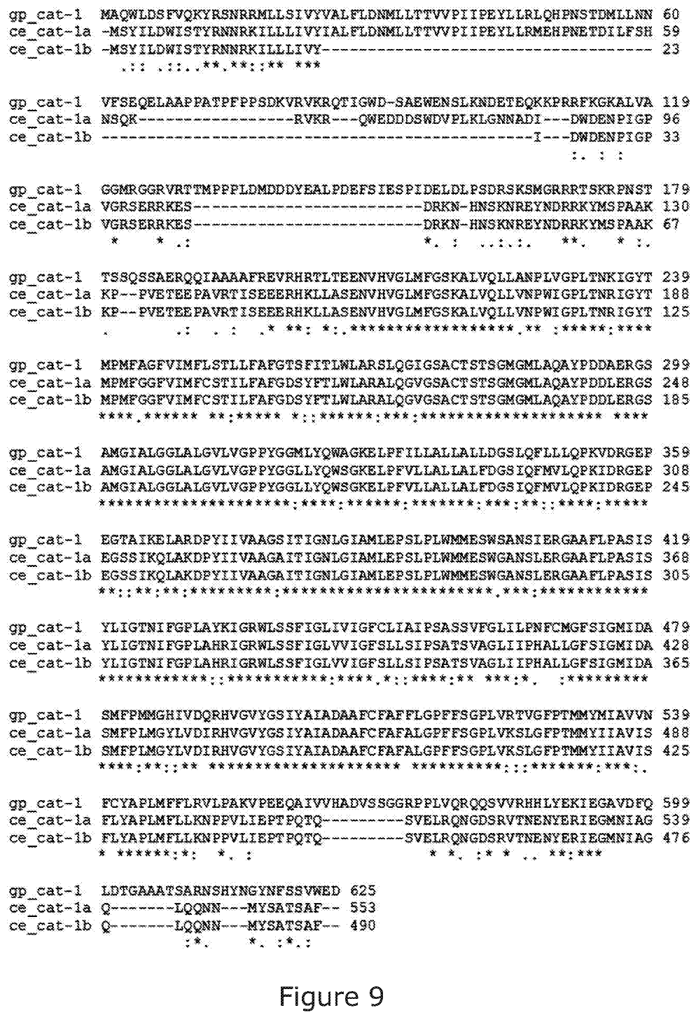

FIG. 9 shows the results of an experiment investigating whether amino acid identity between the C. elegans (ce) and G. pallida (gp) vesicular monoamine transporter, VMAT. C. elegans VMAT is encoded by cat-1 for which two splice variants have been identified, cat-1a and b. The identity between G. pallida CAT-1 and C. elegans CAT-1a is 51.8% and for CAT-1b is 51.5%. In the alignment shown ‘*’ indicates identical amino acids, ‘:’ and ‘.’ indicate similar amino acids at each position.

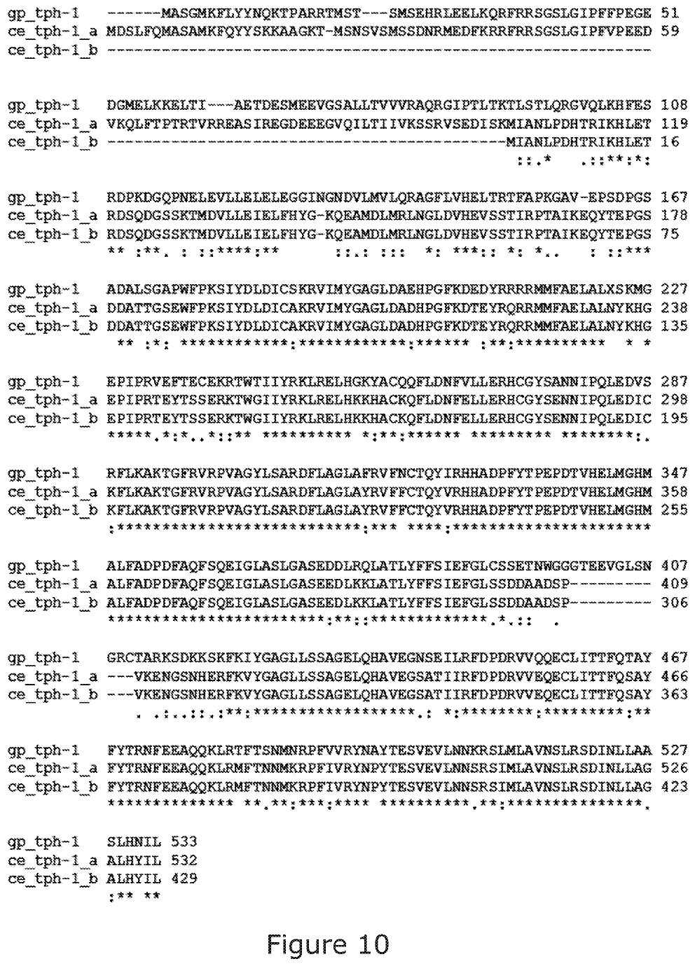

FIG. 10 shows the results of an experiment investigating whether amino acid identity between the C. elegans (ce) and G. pallida (gp) tryptophan hydroxylase, TPH-1. Alignment of amino acid sequences of G. pallida (gp) and C. elegans (ce) TPH-1. In the alignment shown ‘*’ indicates identical amino acids, ‘:’ and ‘.’ indicate similar amino acids at each position. The identity between G. pallida TPH and C. elegans TPH-1a is 63.7%.

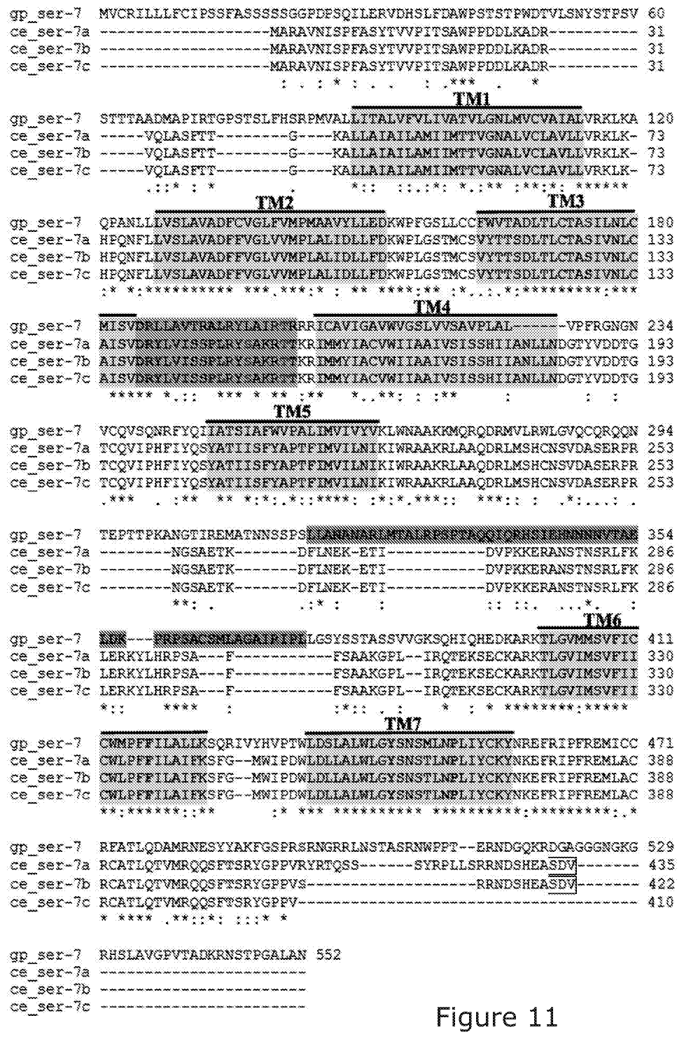

FIG. 11 shows the results of an experiment investigating whether amino acid identity between the C. elegans (ce) and G. pallida (gp) tryptophan hydroxylase, SER-7. Alignment of amino acid sequences of G. pallida (gp) and C. elegans (ce) SER-7. In the alignment shown ‘*’ indicates identical amino acids, ‘:’ and ‘.’ indicate similar amino acids at each position. The identity between G. pallida SER-7 and C. elegans SER-7a is 35%. Motifs are represented as follows; boxed region is PDZ domain; potential PKC phosphorylation sites are green; the domain involved in G-protein coupling is shown in grey; highly conserved residues are in blue including the i2 loop and the GPCR consensus coupling is DRYXXV(I)XXPL (SEQ ID NO. 1; L=leucine or other lipophilic aa). Most studied GPCRs contain DRY, in some channels D is replaced for E and Y for W or F. G. pallida contains DRL. The G. pallida sequence contains A instead of P and this is also seen in the serotonin 1d receptor. All substitutions are known to be permissible for GPCR coupling except for DRY to DRL, which is not known other GPCRs. The i2 loop appears to be central to receptor folding, activation and G protein coupling. Amino acids highlighted in red are conserved in serotonin binding receptors. The amino acids NP shown in purple as involved in receptor sequestration and desensitisation. Shown in turquoise is a region that possibly harbours a splice variant.

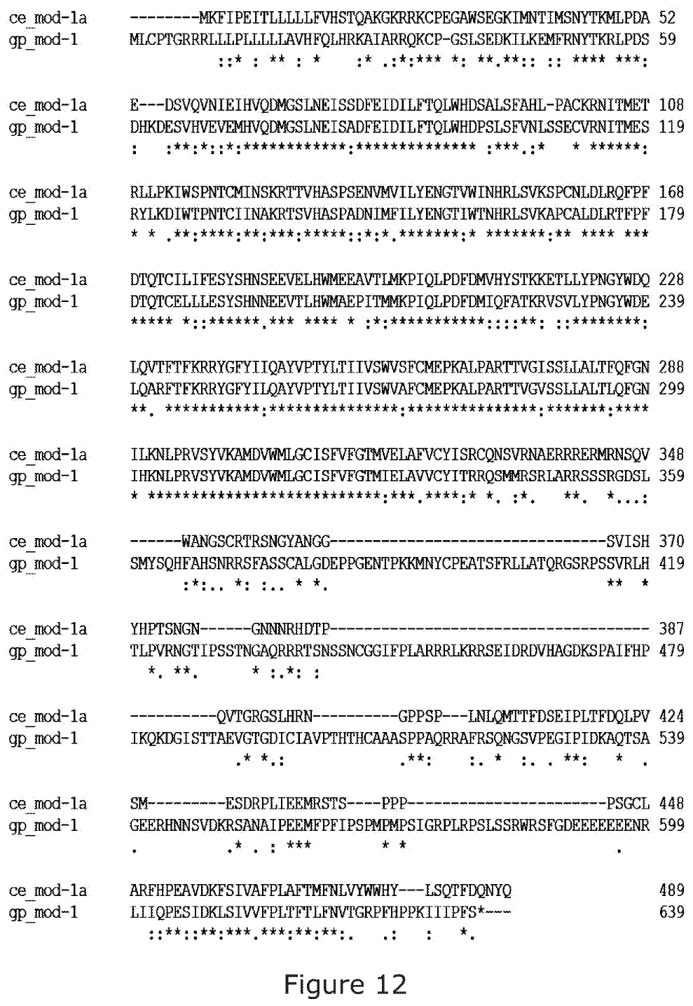

FIG. 12 shows the results of an experiment investigating whether shows the results of an experiment investigating whether alignment of amino acid sequences of G. pallida (gp) and C. elegans (ce) MOD-1. In the alignment shown ‘*’ indicates identical amino acids, ‘:’ and ‘.’ indicate similar amino acids at each position. The identity between G. pallida SER-7 and C. elegans SER-7a is 58.68%.

FIG. 13 shows Chemical Name: (3β,16β,17α,18β,20α)-11,17-Dimethoxy-18-[(3,4,5-trimethoxybenzoyl)oxy]yohimban-16-carboxylic acid methyl ester.

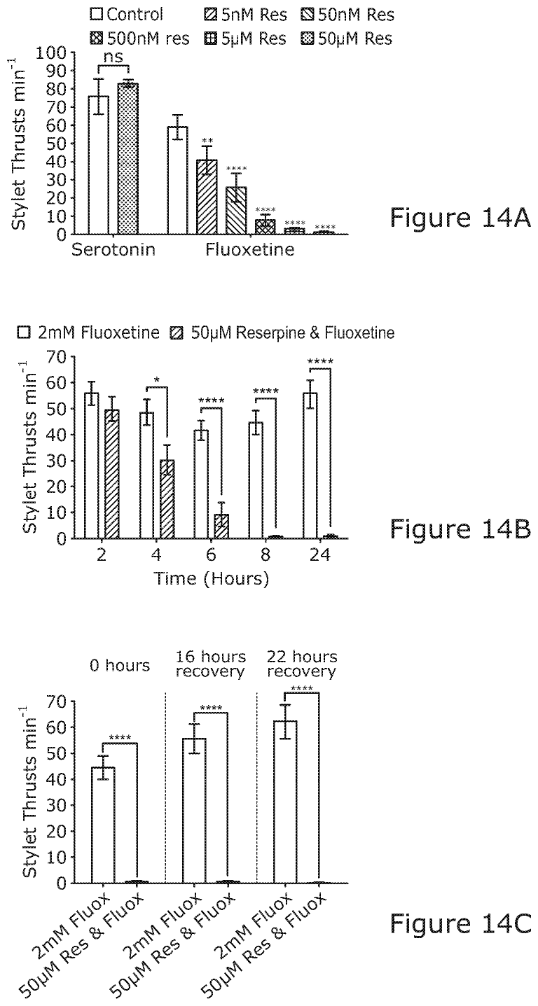

FIG. 14 shows the results of an experiment demonstrating that the vesicular monoamine transporter reserpine prevents the stimulatory effect of the serotonin reuptake inhibitor fluoxetine on stylet activity but not exogenous serotonin. A) To test for effects of reserpine (Res) on stylet thrusting stimulated by exogenous or endogenous 5-HT, J2 G. pallida were soaked in either reserpine or ddH2O for 24 hours. Reserpine-treated J2s were then transferred to a solution of 10 mM 5-HT and reserpine or 2 mM fluoxetine (fluox) and reserpine and ddH2O-treated J2s were transferred to either 5-HT or fluoxetine alone, where stylet thrusting was counted after 30 mins (n=10 worms, mean±s.e mean, two-way ANOVA with Bonferroni post-hoc test). B) To assess the time dependence of the inhibitory effect of reserpine, J2s were exposed to 50 μM reserpine or ddH2O for 24 hours, with some being removed at 2, 4, 6, 8 and 24 hours and transferred into 2 mM fluoxetine where stylet activity was scored after 30 mins. Full inhibition occurred at 8 hrs (n=10, mean±s. e mean, two-way ANOVA with Bonferroni post-hoc test). C) The reversibility of the reserpine effect following protracted washing was assessed by taking J2s treated with 50 μM for 24 hrs and washing in ddH2O. No recovery of the stylet response was seen after 22 hrs wash (n=10, mean±s.e mean, two-way ANOVA with Bonferroni post-hoc test, P<0.0001 for A, B and C). These experiments were conducted in collaboration with Francesca Keefe.

### DESCRIPTION OF THE PREFERRED EMBODIMENTS

Indian snakeroot, an herbal medicine prepared from the roots of the shrub Rauvolfia serpentina, has been used for centuries for its calming action. The major constituent is reserpine which works by depleting a specific class of mood regulating chemical in the brain, the biogenic amines. The present inventors have developed a remarkable new use of reserpine to control a pest of global concern, the plant parasitic nematodes. These microscopic worms invade the roots of crops presenting a severe threat to food production. The present inventors have shown that reserpine disables serotonin signalling in the worm's ‘brain’ that regulates the rhythmic thrusting of the stylet: a lance-like structure that protrudes from its mouth to pierce the plant root and which is essential to its parasitic lifecycle. Thus, reserpine joins nicotine as another intriguing example of Nature evolving its own protection against pests. The present inventors have identified key components of the serotonin signalling pathway in the potato cyst nematode Globodera pallida and show that chemicals that target these sites inhibit the ability of the nematode to invade its host plant. They conclude that biogenic amine transmitters are intimately involved in the worm's parasitic behaviour and provide a new discrete route to crop protection.

Plant parasitic nematodes are microscopic pests that invade plant roots and cause extensive damage to crops worldwide. To investigate mechanisms underpinning their parasitic behaviour the present inventors used a chemical biology approach: They discovered that reserpine, a plant alkaloid known for its antagonism of the mammalian vesicular monoamine transporter VMAT and ability to impart a global depletion of synaptic biogenic amines in the nervous system, potently impairs the ability of the potato cyst nematode Globodera pallida to enter the host plant root. The present inventors showed that this effect of reserpine is mediated by an inhibition of serotonergic signalling and that serotonin is required to activate thrusting motion of the stylet, a lance-like organ that protrudes from the mouth of the worm and which is used to pierce the host root to gain access. Prompted by this they identified further core molecular components of G. pallida serotonin signalling; the synthetic enzyme tryptophan hydroxylase, the G protein coupled receptor SER-7 and the ligand-gated chloride channel MOD-1. They found that inhibitors of tryptophan hydroxylase, SER-7 and MOD-1 phenocopy the plant protecting action of reserpine. Thus targeting the serotonin signalling pathway presents a promising new route to control plant parasitic nematodes.

Plant parasitic nematodes (PPNs) are microscopic worms that invade the roots of crops causing $125 billion of damage per annum. Chemicals deployed to protect crops from PPNs are typically either nematostatics which paralyse the worms by interfering with cholinergic transmission or metabolic poisons. However, the off-target toxicity of these agents is proving unacceptable and they are being removed from use (e.g. EU regulation EC 1107/2009). This presents a growing economic burden that demands new approaches to crop protection. One of the ways to interfere with the infectivity of PPNs is to selectively and discretely disable behaviours that are intrinsic to their parasitic life cycle. The present inventors have demonstrated that serotonin signalling plays an important role in the parasitic life cycle of a PPN and that this provides new targets to protect the host plant.

### Example 1

The subject of this investigation is the sedentary endoparasitic potato cyst nematode, of which there are two major, closely related species Globodera pallida and G. rostochiensis. Together these are important crop pests of worldwide economic significance. The particular focus of this work is the white potato cyst nematode G. pallida, for which there is no single, dominant potato natural resistance gene available. It has a complex life cycle. The parasitic cycle starts when second-stage juveniles (J2s) hatch from eggs and emerge from the cysts in close proximity to the host roots. These non-feeding juveniles have limited time to locate and infect host plant roots. Once the roots are located J2s penetrate an epidermal cell, generally in the zone of elongation, and migrate intracellularly inside the roots to establish a feeding site. Feeding worms progress through subsequent developmental stages with the adult males leaving the roots and females forming a cyst with hundreds of eggs inside it. The plant completes its cycle and the cysts are released into the soil where new worms will emerge in response to signals from suitable host roots in the next potato cropping season. This cycle can even be repeated with a delay of 20 to 30 years, as the eggs are protected and remain dormant in the cysts until favourable conditions for host plant invasion are established.

Disruption of the infectivity cycle at the earliest points possible is predicted to lead to not only a reduction in established nematodes and subsequent population build-up but, importantly, could prevent the root damage associated with the early destructive migration of J2s. This damage can reduce the rate of root growth and decrease rates of uptake for water and nutrients likely contributing to reduced tolerance even amongst some resistant potato cultivars. The early target phase encompasses hatching, directed locomotion towards the host plant, detection of the host plant root and root invasion. An important component of these behaviours is the ability of the worm to appropriately activate its stylet, a hollow lance-like structure that can protrude from the mouth of the worm, and is implicated in both hatching and penetration of the host plant root. Once inside the host root, pharyngeal gland secretions introduced via the stylet into a selected plant cell are intimately involved in establishing the feeding site from which the stylet itself provides the sole route for nutrient acquisition. All of these behaviours are the output of the nematode's nervous system but little is currently understood of their neurobiology.

To provide a better understanding of the neurobiology underpinning the PPN parasitic life cycle we have adopted a chemical biology approach and screened neuroactive chemicals for their impact on G. pallida behaviour. The inventors have found a remarkable effect of reserpine, which impairs the ability of G. pallida J2s to invade the host plant root. Reserpine is a naturally occurring plant alkaloid from the shrub Rauvolfia serpentina. Extracts of the roots of this plant, commonly called Indian snakeroot, have been used in herbal medicine for centuries for their sedative properties. Last century reserpine was one of the first drugs to be registered for the treatment of hypertension and was also used as an antipsychotic. The molecular mode of action lies in its potent inhibition of the vesicular monoamine transporter, VMAT (FIG. 1 A) which elicits a global depletion of biogenic amines in the nervous system. These biogenic amine neurotransmitters are present throughout the animal phyla but there are discrete differences between the invertebrates and vertebrates. Both use serotonin and dopamine but invertebrates deploy octopamine and tyramine instead of noradrenaline and adrenaline.

Biogenic amine signalling in nematodes has been best characterised in the non-parasitic genetically tractable organism Caenorhabditis elegans. In C. elegans the role of serotonin, dopamine, octopamine and tyramine has been subjected to extensive investigation and these amines underpin a diverse range of behaviours with overlapping roles in feeding, metabolism and cue-dependent behaviours. This has informed understanding of its role in animal parasitic nematodes but there is a paucity of information for plant parasitic nematodes.

The present inventors have demonstrated the plant protecting properties of reserpine and shown that it exerts this effect through a potent inhibition of the plant parasitic nematode vesicular monoamine transporter. This prompted them to identify further core molecular components on the serotonin signalling pathway in G. pallida and targeting these with chemical inhibitors can also protect plant seedlings from PPN infection. Together this argues that targeting serotonin signalling pathways presents an under-utilised and promising new route to control of not only potato cyst nematodes, but also other economically important PPNs.

### Results

The inhibitory effect of reserpine on G. pallida root invasion behaviours Pre-incubation of G. pallida J2s with 100 μM reserpine prior to their inoculation onto potato hairy roots in tissue culture significantly decreased the number of nematodes present in the roots 13 days later (FIG. 1A). In order to invade the host root the J2s must be motile and capable of thrusting their stylet in a rhythmic manner to pierce the plant cell walls. The inventors tested the effect of reserpine on G. pallida motility in a dispersal assay in which J2s were placed in the centre of an agar arena and the number of worms present at the origin after a given period of time was scored. The inventors found that pre-incubation with reserpine (50 μM) for 18 h prior to the assay brought about a significant reduction in this behaviour (FIG. 1B) consistent with previous reports that monoaminergic transmission is required for motility of plant parasitic nematodes and suggesting reserpine may interfere with motility to prevent host plant invasion.

Previous investigations of the role of biogenic amines in plant parasitic nematode motility have provided evidence for specific involvement of serotonin. Furthermore, serotonin is a known activator of stylet thrusting. The inventors showed that reserpine depletes endogenous serotonin in the circuit that is required to stimulate stylet activity (FIG. 2A), an effect that would contribute to the impairment of host plant invasion. As J2s do not spontaneously stylet thrust in vitro testing this hypothesis required a method for activating the stylet against which the inhibitory action of reserpine could be tested. To achieve this we deployed fluoxetine, more commonly known as the antidepressant Prozac. This compound blocks the synaptic plasma membrane serotonin transporter, and by preventing re-uptake of synaptically released serotonin, increases its concentration in the synaptic cleft which in turn activates the postsynaptic receptors (FIG. 2A). Stylet thrusting can be visually scored by counting the frequency of projection/retraction cycles of the stylet (FIG. 2B): Both serotonin and fluoxetine elicited a time-dependent and concentration-dependent stimulation of stylet thrusting. For both compounds the maximal response was seen after 30 min exposure and the concentration-dependence of the response after 1 h is shown in FIG. 2C. The concentration-response curve for serotonin reached a maximum plateau above 2 mM whilst fluoxetine had a bell-shaped concentration response curve. This may indicate serotonin receptor antagonism by fluoxetine at higher concentrations, a phenomenon reported previously for C. elegans. The inventors tested the effect of reserpine against the maximally effective concentration of serotonin (10 mM) and fluoxetine (2 mM): Reserpine potently blocked the stylet response to fluoxetine but not the response to serotonin (FIG. 2D) consistent with an interpretation in which the response to fluoxetine requires the presence of correctly stored vesicular serotonin which is depleted by the VMAT blocking action of reserpine (see FIG. 2A). Together these data suggest that reserpine may deplete endogenous serotonin in neural circuits regulating motility and stylet thrusting leading to an inability of the nematode to invade the host root. Furthermore, it indicates that serotonin signalling plays a key role in host plant invasion behaviour and therefore the inventors embarked on a characterisation of core components of serotonergic neurotransmission with a view to testing these as potential targets for crop protection.

Cloning and Functional Characterisation of G. pallida VMAT

The inventors identified the molecular target for reserpine in G. pallida using the sequence of the C. elegans vesicular monoamine transporter cat-1 (WBGene00000295) which is well characterised and for which there are two isoforms, cat-1a and cat-1b. We mined the G. pallida draft genome assembly (4) and identified a cat-1 homologue (GPLIN_000654600 in contig pathogens_Gpal_scaffold_196_20:1021-4946) which we designated Gpa-cat-1. We cloned two variants of G. pallida cat-1 from J2 G. pallida cDNA, which had 2 and 3 amino acid differences, respectively, from the published sequence. These amino acid changes could not be assigned to any known functions of CAT-1 domains in C. elegans and are thus likely to be allelic variants. C. elegans CAT-1a has 51.8% amino acid identity and CAT-1b has 51.5% amino acid identity to G. pallida cat-1 (FIG. 9).

In adult hermaphrodite C. elegans the gene encoding VMAT, cat-1, is expressed in all serotonergic and dopaminergic neurons. C. elegans cat-1 (ok411) functional null mutants exhibit a distinctive feeding phenotype; they cannot sustain fast pharyngeal pumping on food. This reflects the major role that serotonin has in stimulating pharyngeal pumping in the presence of food. To test whether the sequence identified in G. pallida is a functional orthologue of cat-1 we expressed G. pallida cDNA predicted to encode cat-1, which we designated ppn cat-1, in a C. elegans strain carrying ok411, the null mutation for cat-1, and investigated if this would rescue the C. elegans pharyngeal phenotype. The two cloned allelic variants of Gpa-cat-1 were both individually expressed in C. elegans from a pan-neuronal promoter psnb-1 to test for rescue of the cat-1 pharyngeal phenotype and this was compared to rescue achieved by expression of C. elegans cat-1 from the same promoter. As C. elegans cat-1a is more similar to G. pallida cat-1 this was used as the C. elegans sequence for the rescue experiments. Transformed worms were identified by co-expression of gfp from the myo-3 promoter which provides readily identifiable fluorescence in the body wall muscle of transgenic lines. The control worms expressing myo-3;gfp had the same pumping rate as untransformed cat-1 mutants (myo-3;gfp 182 f 2 and cat-1 192 f 2 pumps min-1, respectively; p>0.05) indicating expression of the transformation marker alone does not impact on pharyngeal pumping. Gpa-cat-1 rescued the pharyngeal pumping phenotype of cat-1 (ok411) mutant worms to the levels of wild type in a similar manner to expression of C. elegans cat-1 (FIG. 3A). Thus Gpa-cat-1 encodes a functional vesicular monoamine transporter capable of restoring function in C. elegans cat-1 mutants. The same rescue was observed using either Gpa-cat-1a or Gpa-cat-1b supporting the conclusion that both these sequences encode a functional VMAT in G. pallida.

The function of CAT-1 may also be assessed through the pharmacological response of the worms to fluoxetine. In well fed C. elegans in the presence of food (bacteria) the impact of fluoxetine on pharyngeal pumping is not apparent as under these conditions the worms' pharyngeal activity is maximally activated by the presence of the bacterial. However, in the absence of bacteria pharyngeal activity is much reduced: Under these conditions pharmacological stimulation of pharyngeal pumping with fluoxetine, which elevates synaptic serotonin a key signal for activation of pumping, can be observed. The stimulatory effect of fluoxetine on C. elegans pharyngeal pumping in the absence of food was maximal after 1 h exposure and concentration-dependent (FIG. 3B). This stimulation was not observed in the C. elegans cat-1 mutant consistent with a model in which fluoxetine stimulates pharyngeal pumping by elevating synaptic levels of serotonin by blocking its reuptake via the plasma membrane transporter (FIG. 2A). Higher concentrations of fluoxetine (1 mM and 2 mM) or longer exposure times at 500 μM, did not cause a stimulation of pharyngeal pumping which probably reflects that fact that at higher concentrations fluoxetine is an antagonist of serotonin receptors thus any stimulatory action would be inhibited by concomitant receptor blockade. Importantly, with respect to establishing the function of ppn-cat-1, the low dose stimulatory effect of fluoxetine on pharyngeal pumping that was absent in the C. elegans cat-1 mutant was restored by expression of either wild-type C. elegans cat-1 or ppn-cat-1 (FIG. 3B).

This confirms the identification of VMAT from G. pallida.

Cloning and Functional of G. pallida Tph-1

To further test the role of serotonin in the parasitism of PPNs the inventors investigated the role of the synthetic enzyme tryptophan hydroxylase. The C. elegans gene encoding tryptophan hydroxylase tph-1 (WBGene00006600) is on chromosome II and has two isoforms, tph-1a and tph-1b. C. elegans tph-1a is assembled from 11 exons, while tph-1b has a shorter 5′ terminal and is assembled from 9 exons. The G. pallida genome assembly contains a putative orthologue (GPLIN_000790300) that we designated Gpa-tph-1. A single isoform was cloned from cDNA that more closely resembles the longer C. elegans Ce-tph-1a. The translated product has 63.7% amino acid identity to C. elegans TPH-1a and 57.7% amino acid identity to C. elegans TPH-1b (FIG. 10).

A C. elegans functional null mutant for tph-1 (mg280) displays behavioural and metabolic changes that resemble food deprivation. This is because the tph-1 mutant has reduced pharyngeal pumping due to the lack of serotonin and its ability to ingest food is impaired. To confirm the functional identity of Gpa-tph-1 as a genuine tryptophan hydroxylase we tested the ability of this gene to rescue the C. elegans tph-1 (mg280) pharyngeal phenotype and compared this to the rescue obtained by expression of Ce-tph-1a. Injection of tph-1 with the transformation marker, myo-3;gfp, alone did not change pumping rate (myo-3;gfp 179 f 4 pumps per minute; tph-1 169 f 3 pumps min-1; p>0.05). Consistent with a functional role as a tryptophan hydroxylase, G. pallida tph-1 rescued the pumping phenotype of the C. elegans tph-1 (mg280) mutant to the levels of wild type in a similar manner to expression of C. elegans tph-1 (FIG. 4A). This supports the conclusion that G. pallida and C. elegans tph-1 are functional orthologues.

The inventors next wanted to interrogate the functional importance of G. pallida TPH-1 in root invasion. Unfortunately, gene interference using siRNA has non-specific toxic effects on G. pallida confounding the use of this experimental approach. Therefore they investigated pharmacological blockers as a potential route to establish the functional involvement of serotonin signalling in G. pallida parasitism. They tested whether 4-chloro-DL-phenylalanine methyl ester hydrochloride (CPA), which is an inhibitor of the mammalian tryptophan hydroxylase [31], could be used as a chemical tool to test the function of TPH in G. pallida. To achieve this the inventors first established the ability of CPA to block both C. elegans and G. pallida TPH-1 expressed in the C. elegans tph-1 mutant. Indeed, we found that pharyngeal pumping of wild type C. elegans was significantly inhibited by CPA (10 mM) to a level that phenocopied the tph-1 mutant and furthermore exposure of tph-1 to CPA did not cause any further reduction in pharyngeal pumping (FIG. 4B). The ability of CPA to inhibit pharyngeal pumping was restored in tph-1 mutants by expression of either C. elegans or G. pallida tph-1 (FIG. 6B). These data are consistent with CPA acting as a selective inhibitor of C. elegans and G. pallida TPH-1.

Targeting TPH-1 Impairs G. pallida Root Invasion Behaviour

We used CPA to test the role of the enzyme encoded by Gpa-tph-1 in serotonin-mediated stylet thrusting of G. pallida. G. pallida J2s were treated with 10 mM CPA overnight after which treated and control worms were soaked in serotonin (10 mM) or fluoxetine (2 mM) for 30 min and stylet thrusting visually scored. The worms incubated in CPA overnight had reduced stylet thrusting in response to fluoxetine but maintained their response to serotonin suggesting that CPA inhibited TPH-1 enzyme activity and thus serotonin synthesis (FIG. 5A) and the response to fluoxetine. Treatment of J2s with CPA (100 μM) prior to infection significantly reduced the number of nematodes present in potato roots 13 days after inoculation (FIG. 5B) adding further evidence to support a role for serotonin signalling in root invasion.

Functional and pharmacological characterisation of G. pallida serotonin receptors Four receptors are involved in serotonin signalling in C. elegans, three of them are metabotropic G-protein coupled receptors (SER-1, SER-4 and SER-7) and the fourth is a serotonin-gated chloride channel MOD-1. Similar to their homologues in humans, SER-1 and SER-4 have a low affinity for serotonin whilst SER-7 has a high affinity. Interestingly, MOD-1, which has a high affinity for serotonin, is not found in vertebrates. G. pallida putative orthologues of the C. elegans genes encoding serotonin receptors were identified by reciprocal best BLAST hit analysis of the G. pallida predicted gene complement. This identified candidate G. pallida genes encoding SER-4, SER-7 and MOD-1 receptors although a clear orthologue of SER-1 was not found (Table 1). In this study we focused on a further characterisation of SER-7, selected because of its key role in regulating feeding behaviour in C. elegans and MOD-1, selected because of its important role in regulating locomotion underpinning exploration in the anticipation that these receptors may subserve similar behaviours in the plant parasitic nematodes.

SER-7 is a key determinant of C. elegans pharyngeal pumping. This is demonstrated by the observation that C. elegans null mutants for ser-7 display irregular pumping on food and have a reduced response to serotonin stimulated pumping in the absence of food. The inventors cloned the closest homologue of C. elegans ser-7 from G. pallida (FIG. 11). To test whether this G. pallida sequence encodes a bona fide serotonin receptor, we tested its ability to rescue of this latter C. elegans ser-7 pharyngeal phenotype, that is the lack of stimulatory response to serotonin, by expression of either C. elegans ser-7 or the putative G. pallida ser-7 from the pan-neuronal promoter snb-1. We found that expression of either gene restored the sensitivity of the pharyngeal system to serotonin (FIG. 6A). In these in vivo whole organism experiments a high concentration of serotonin is required to activate the pharynx as the worm's cuticle presents a permeability barrier to drug access confounding discrete pharmacological analysis of the SER-7 receptor. To circumvent this we analysed the pharyngeal response to serotonin in a cut-head assay in which the intact pharynx is carefully cut from the rest of the worm (FIG. 6B). This enables drugs to access the tissue without having to cross the nematode cuticle and permits more precise interrogation of the concentration dependence of the compounds' effects on pharyngeal activity. The isolated pharynx is 2 to 3 orders of magnitude more sensitive to the stimulatory action of serotonin compared to the intact worm. Consistent with this, wild type worms showed a concentration-dependent increase in pharyngeal pumping in response to serotonin (EC50 223 nM, 95% confidence from 164 nM to 304 nM) whilst ser-7 (tm1325) mutants did not respond even to 100 μM serotonin (FIG. 6C). This is in agreement with earlier studies showing SER-7 is the key pharyngeal receptor for serotonin activation of feeding. Pharyngeal pumping in transgenic worms expressing either psnb-1::Ce-ser-7a or psnb-1::Gpa-ser-7 was activated by serotonin with an EC50 of 782 nM (95% confidence from 457 nM to 1.34 μM) and EC50 3.9 μM (95% confidence from 2.16 μM to 7.08 μM), respectively (FIG. 6C). We used this cut head pharmacological assay to test a putative antagonist of the SER-7 receptor, methiothepin and showed that this compound blocked the stimulatory effect of serotonin in transgenics expressing either C. elegans ser-7 or G. pallida ser-7 (FIG. 6D) with around 50% inhibition at 100 nM. Together, this supports the conclusion that Gpa-ser-7 encodes a G. pallida serotonin receptor which has the closest similarity to C. elegans SER-7.

The present inventors also cloned a putative orthologue of the C. elegans serotonin-gated chloride channel from G. pallida (FIG. 12). This receptor belongs to a family of biogenic amine-gated chloride channels which are unique to the invertebrate phyla and thus of particular interest with respect to the development of novel chemical control agents with selective toxicity towards plant parasitic nematodes. The C. elegans mod-1 null mutant (ok103) has a distinctive phenotype in that it is does not exhibit the acute paralysis induced in wild type by a high concentration (33 mM) of serotonin. The inventors found that the putative G. pallida sequence encoding the orthologue of C. elegans MOD-1 receptor could rescue this serotonin-induced phenotype in ok103 as robustly as the expression of a wild type C. elegans mod-1 (FIG. 7A). For these experiments they cloned the putative native C. elegans mod-1 promoter to drive expression of both the G. pallida and C. elegans sequences. Like SER-7, C. elegans MOD-1 is also blocked by methiothepin therefore to further characterise the G. pallida receptor they compared the ability of methiothepin to block C. elegans and G. pallida MOD-1. The inventors showed that the mod-1 dependent serotonin-induced paralysis in both wild type worms and in worms expressing G. pallida mod-1 was blocked by methiothepin (FIG. 7B). This supports the conclusion that the G. pallida sequence encodes an orthologue of the C. elegans serotonin-gated chloride channel MOD-1.

In view of the evidence that a low micromolar concentration of methiothepin can block both G. pallida SER-7 and MOD-1 the inventors speculated that this compound might provide insight into whether either, or both, of these receptors are involved in host plant invasion behaviour. They found that methiothepin was a potent antagonist of serotonin-induced stylet thrusting in G. pallida J2s (FIG. 12A) and blocked root invasion (FIG. 8B). Interestingly, stylet thrusting is also implicated in egg hatching and they found that methiothepin potently inhibited the emergence of J2s from eggs although the J2s inside the eggs appeared viable (FIG. 8C). In support of a role for serotonin we identified two putative neurons in the anterior nervous system that were labelled using an in situ hybridisation probe targeted at tph-1 (FIG. 8D). These data are consistent with the interpretation that methiothepin acts as an antagonist of either, or both, SER-7 and MOD-1 to block serotonin activated stylet thrusting which is required for hatching and root invasion.

### Methods

Caenorhabditis elegans Strains and Culture

C. elegans were grown on Nematode Growth Medium (NGM) plates seeded with Escherichia coli (OP50 strain) at 20° C. according to standard protocols]. N2 (Bristol strain) C. elegans were employed as wild-type. GR1321 is a strain carrying a deletion in mg280 allele for tph-1 (ZK1290.18) and a 9.8 kb deletion in vs166 for cam-1. cam-) encodes a receptor tyrosine kinase of the immunoglobulin superfamily. This strain displays 15 phenotypes and was used in the original studies on C. elegans tph-1 gene characterisation. Another strain, MT14984, contains a deletion only in the tph-1 gene and displays one phenotype: reduced pharyngeal pumping (CGC, made by Dan Omura). However, this strain was not available to order from CGC at the time when the experiments were carried out. GR1321 was outcrossed with N2 C. elegans four times (CGC database) and additionally twice more in our laboratory. ser-7 (tm1325) strain DA2100 carries a 742 bp deletion and 38 bp insertion and displays 5 phenotypes, one of which is reduced pharyngeal pumping in response to serotonin. It was outcrossed with N2 C. elegans ten times (CGC database). cat-1 encodes a vesicular monoamine transporter (VMAT) and is an orthologue of human VMATs. cat-1 C. elegans mutant strain RB681, ok411 allele, has a 429 bp deletion and is predicted to be a functional null (Wormbase). MT9668 mod-1 (ok1030) V—the allele ok103 is null allele due to the molecular nature of the mutation, covering the entire genomic sequence corresponding to mod-1 gene (Rajesh Ranganathan et al. 2000). This strain was outcrossed with N2 C. elegans six times (CGC database). mod-) encodes an ionotropic 5-HT receptor, a 5-HT-gated chloride channel.

Transgenic C. elegans (described below) were always assayed in parallel with positive and negative controls for the pharyngeal pumping phenotype variants i.e. on the same day with N2 and mutant strain C. elegans, respectively.

Globodera pallida maintenance and culture Cysts of G. pallida (Pa2/3; population Lindley) were extracted from infested sand/loam following growth of host ‘Desiree’ potato plants. Dried cysts were treated with 0.1% malachite green solution for 30 mins followed by extensive washing in tap water. Cysts were then incubated in an antibiotic cocktail at 4° C. overnight and washed five times with sterile tap water. To induce hatching, cysts were placed in a solution of 1 part potato root diffusate to 3 parts ddH2O. Root diffusate was obtained by soaking washed roots of three week-old potato plants in tap water at 4° C. overnight at a rate of 80 g root/litre. The diffusate was filter-sterilised before use. Significant numbers of J2 typically began hatching 1 week after rehydration in the presence of potato root exudate. Only J2 that had hatched within the previous 24 hours were used for experiments. Prior to the experiments the J2s were washed in ddH2O to remove potato root diffusate.

### Drugs and Chemicals

Serotonin creatinine sulphate monohydrate (5-HT), methiothepin, imipramine hydrochloride and 4-chloro-DL-phenylalanine methyl ester hydrochloride (CPA) were purchased from Sigma Aldrich (Dorset, UK). Fluoxetine hydrochloride was purchased from Enzo Life Sciences (Exeter, UK) and serpasil phosphate (reserpine) from Novartis (Surrey, UK). Agar plates containing compounds were prepared as follows: For serotonin creatinine sulphate monohydrate the compound was added to 60° C. NGM and stirred to give a 10 mM final concentration. The NGM was then used to pour plates. For fluoxetine and CPA the compounds were dissolved in M9. 500 μl of each compound was evenly pipetted over the surface of a 6 cm plate containing 10 ml NGM to give the final desired concentration. The plates were allowed to dry for 2 hours before use. Serotonin and fluoxetine plates were stored at 4° C. for 1-2 weeks. Serpasil phosphate plates were prepared in a similar manner except the compound was dissolved in double distilled water and then diluted in HEPES buffer (pH 7.4). For stylet thrusting assays drugs were added to ddH2O (0.1% BSA) buffered to pH 7.4 to achieve the desired concentration. Methiothepin plates were prepared as described for the rest of drug except 10 μM dissolved in water was added to 10 ml of NGM. These plates were used fresh in every single experiment.

Structural characterisation of C. elegans and G. pallida tph-1, ser-7, cat-1 and mod-1 G. pallida putative orthologues of C. elegans tph-1 (WBGene00006600), ser-7 (WBGene00004780), cat-1 (WBGene00000295) and mod-1 (WBGene00003386) were first identified by BLASTP searches of the predicted protein dataset (May 2012) at http://www.sanger.ac.uk/cgi-bin/blast/submitblast/g_pallida followed by reciprocal searches of the C. elegans protein set at wormbase.org. Each predicted G. pallida gene was located in the draft genome assembly after a BLASTN search of the scaffolds via the G. pallida BLAST server as above. The predicted gene models were manually assessed for concordance with the mapped transcripts and primers were designed to amplify the complete coding regions.

The primary amino acid sequences of C. elegans and G. pallida CAT-1, TPH-1, SER-7 and MOD-1 proteins were aligned using UNIPROT Clustal Omega program.

Default parameters: The default transition matrix is Gonnet, gap opening penalty is 6 bits, gap extension it 1 bit. Clustal-Omega uses the HHalign algorithm and its default settings as its core alignment engine. The algorithm is described in Söding, J. (2005) ‘Protein homology detection by HMM-HMM comparison’. Bioinformatics 21, 951-960.

Cloning of C. elegans and G. pallida Tph-1, Ser-7, Cat-1 and Mod-1

RNA was extracted from mixed stages C. elegans and from J2 G. pallida using an RNeasy Mini Kit (Qiagen, UK) according to the manufacturer's instructions. cDNA was reverse transcribed from 200 ng of total RNA using Superscript III reverse transcriptase with oligodT primers (Life Technologies, UK). C. elegans tph-1a, ser-7a and mod-1a were then amplified by PCR from 2 μl of cDNA using proof reading Phusion DNA polymerase (Thermo Scientific, UK), followed by addition of 1 μl of Taq DNA polymerase (Promega, UK), and continued with 10 min at 72° C. Sizes of PCR products were estimated on an agarose gel and cloned into pCR8/GW/TOPO vector according to the manufacturer's instructions (Life Technologies, UK). TOP10 chemically competent cells (Life Technologies, UK) were transformed with TOPO reaction and plated onto spectinomycin (100 mg/ml) selective plates overnight at 37° C. The orientation of the cloned genes was confirmed by digests with restriction enzymes. Subsequently, colonies that contained genes in 5′ to 3′ orientation were sequenced by a commercial company (Eurofins Genomics, UK). Both C. elegans tph-1a and ser-7a sequences were in agreement with published data.

C. elegans Psnb-1 promoter was digested from pBK3.1 vector (Wang et al., 2001) with HindIII and XbaI enzymes. pDEST vector (Life Technologies, UK) was digested with the same restriction enzymes and the fragments for Psnb-1 promoter and linear pDEST vector were purified out of the agarose gel.

Psnb-1 promoter was ligated into pDEST vector in a 3:1 ratio with T4 DNA ligase (Promega, UK) overnight at 4° C. The ligation product was amplified in One Shot ccdB Survival 2 T1R Competent Cells (Life Technologies) grown on ampicillin (100 μg/μl) and chloramphenicol (30 sg/ml) selective plates. DNA insertion was confirmed by restriction digests and sequenced by Eurofins Genomics, UK. All sequenced vectors contained the predicted sequence for Psnb-1.

Pmod-1 C. elegans promoter (was amplified from genomic DNA using forward (NheI) 5′-AAGCTAGCAAGTTGATGTTTCACGGAACG-3′ (SEQ ID NO. 2)_and reverse (KpnI) 5′-AGGTACCCTTGTCATAATTTTCTTTCACC-3′ (SEQ ID NO. 3) primers. pDEST vector (Life Technologies, UK) was digested with both NheI and KpnI restriction enzymes, and mod-1 promoter was ligated into pDEST vector following the same protocol described above.

The in vitro recombination between an entry pCR8/GW/TOPO clone containing C. elegans or G. pallida tph-1, ser-7, cat-1 and mod-1 and a destination vector pDEST; Psnb-1 was performed using Gateway® LR Clonase® II enzyme mix (Life Technologies, UK) according to the manufacturer's instructions to generate expression clones for C. elegans microinjections. The resulting plasmids were propagated in TOP10 cells grown on ampicillin selective plates (100 sg/ml) and confirmed by restriction digests and sequencing.

| Gene | Forward primer | Reverse primer |
|---|---|---|
| ce ser-7a | AATGGCCCGTGCAGTCA | GCTAGACGTCACTT |
| | ACATATC (SEQ ID NO. 4) | GCTTCGTGAC |
| | | (SEQ ID NO. 5) |
| gpa ser-7 | GTGCCCTAATGGTCTGTC | CCCAAGCTTTGGGTT |
| | GG (SEQ ID NO. 6) | CAGCATGCTATTTG |
| | | (SEQ ID NO. 7) |
| ce tph-1a | TATGGATTCGTTGTTTCA | CACGGAAACTCAAAC |
| | GATG (SEQ ID NO. 8) | TACAGG |
| | | (SEQ ID NO. 9) |
| gpa tph-1 | GTAAAAATGGCTTCCGGC | CACTTCAATTAGTTG |
| | ATG (SEQ ID NO. 10) | AAATAG |
| | | (SEQ ID NO. 11) |
| ce cat-1a | TATGTCGTACATTCTTGA | CTAAAATGCACTGGT |
| | TTGGATC (SEQ ID NO. 12) | TGCAGAG |
| | | (SEQ ID NO. 13) |
| gpa cat-1 | ATTAAAATGGCCCAATG | TTTTGGAAGCGTTTG |
| | GTTG (SEQ ID NO. 14) | TTGTGC |
| | | (SEQ ID NO. 15) |
| ce mod-1a | ATGAAGTTTATTCCTGAA | TCACTGATAGTTTTG |
| | ATCACAC (SEQ ID NO. 16) | ATCGAAAC |
| | | (SEQ ID NO. 17) |
| gpa mod-1 | ATGCTTTGCCCCACCGGA | TTAGCTGAACGGAAT |
| | CGTCGTC (SEQ ID NO. 18) | GATTATTTTC |
| | | (SEQ ID NO. 19) |

C. elegans Transgenic Experiments

tph-1 (mg280), ser-7 (tm1325), cat-1 (ok411) C. elegans were injected with plasmids to drive expression of either C. elegans or G. pallida tph-1, ser-7 or cat-1 from a synaptobrevin promoter, Psnb-1, which drives expression in all neurons. Mod-1 (ok103) C. elegans were injected with a plasmid to drive expression of either C. elegans or G. pallida mod-1 from the native promoter Pmod-1. The plasmids were injected at 30 ng μl−1. Transformed worms were identified by co-injecting L3785 (Pmyo-3::gfp) plasmid (50 ng μl−1) (a gift from Andrew Fire), which drives expression of green fluorescent protein (GFP) from the body wall muscle promoter Pmyo-3. The co-injected gfp transformation marker forms an extra-chromosomal array with the plasmids carrying the gene sequence and thus worms with fluorescent green body wall muscle can be identified as carrying the plasmid of interest. For all the experiments, at least two independently transformed stable lines of transgenic C. elegans expressing C. elegans or G. pallida tph-1, ser-7 or cat-1 were assayed. Results for the independent lines for each construct were in good agreement and the data presented are the pooled data from these independent lines.

Pharmacological Characterisation of the Transgenic C. elegans Strains in Pharyngeal Pumping Assays.

Experiments were performed on one day old age synchronised worms by picking L4 stage a day before the assay. Due to the translucent nature of the worm, pharyngeal pumping may be scored in the intact animals by counting the movements of the grinder in the terminal bulb: one complete up and down motion is counted as a single pharyngeal pump. The number of pharyngeal pumps was counted on E. coli OP50 in N2, in the mutants tph-1 (mg280), ser-7 (tm1325), cat-1 (ok411) and in mutants with ectopic expression of C. elegans (ce) or G. pallida (ppn) tph-1, ser-7 or cat-1 in all of the neurons (Psnb-1 promoter).

To test the effects of CPA (4-chloro-DL-phenylalanine methyl ester hydrochloride) on pharyngeal pumping one day old adult C. elegans for N2, tph-1 (mg280) and tph-1-1 (mg280) with ectopic expression of C. elegans (ce) or G. pallida (Gpa) tph-1 were placed onto E. coli OP50 containing CPA on NGM plates and the number of pharyngeal pumps on food per min was scored after 2 and 18 hours.

Pharyngeal pumping of ser-7 mutants expressing either C. elegans or G. pallida ser-7 was tested after 20 min exposure to 10 mM serotonin in the absence of food. Additionally, an intact pharynx containing a terminal bulb was dissected from the rest of the worm with a razor blade. The pharyngeal preparation was placed into 3 ml of Dent's saline (with 0.1% BSA and the drugs 5-HT or methiothepin) in a 25 mm Petri dish. Pharyngeal pumps were scored visually, as for the intact worms, for 1 min. For controls, the pharyngeal pumping was scored in Dent's saline (0.1% BSA) without drugs with appropriate vehicle controls.

To test the effects of fluoxetine one day old C. elegans for N2, cat-1 (ok411) and cat-1 (ok411) with ectopic expression of C. elegans (ce) or G. pallida (Gpa) cat-1 were placed onto unseeded NGM plates containing fluoxetine and the number of pharyngeal pumps per min was scored after 1 h and 18 h.

Pharmacological Characterisation of the Transgenic C. elegans Strains in Thrashing Paralysis Assay

In order to study the functionality of both C. elegans and G. pallida MOD-1 channels we examined the pharmacological response of MOD-1 to serotonin, using a thrashing paralysis assay as described (Rajesh Ranganathan et al. 2000). Briefly, 10 to 20 animals (L4+1 day stage) were placed in 200 μl of 33 mM serotonin (creatinine sulphate salt; Sigma) dissolved in M9 buffer in 96-well microtitre wells. The serotonin resistance was scored, observing the swimming behaviour, every minute for a total time of 20 min. An animal was considered as immobile if it did not exhibit any swimming motion for a period of 5 s.

To test whether methiothepin was able to block the serotonin-induced paralysis, we carried out the thrashing paralysis assay as described above, but with a pre-incubation with or without 10 μM methiothepin for 120 min on an NGM plate with E. coli OP50 bacteria before placing the worms in the wells of the microtitre plate with serotonin. For the methiothepin treatment group, 10 μM methiothepin was included in the wells of the microtitre plate. Wild type (N2), mod-1 (ok103), and the transgenic strains expressing gpa-mod-1 in mod-1 (ok103) were tested.

G. pallida Stylet Thrusting Assays

Stylet thrusting assays were conducted in 20 mM HEPES buffered ddH2O, with pH adjusted to 7.4 with NaOH. J2s were pipetted into 3 ml of the test solutions in 30 mm petri dishes and the number of stylet thrusts per minute was counted at various time points as stated in figure legends. A single movement of the stylet knob forwards and then backwards to its original position was counted as one stylet thrust. Control assays were conducted in the presence of either 20 mM HEPES alone or 20 mM HEPES with drug vehicle, as indicated in figure legends. All assays were conducted at room temperature (20-22° C.). All drug solutions were made up on the day of use. Each solution contained 0.01% bovine serum albumin to prevent worms from sticking to the Petri dish. Reserpine was dissolved in 100% acetone and then 1 in 200 dilution was made using Hepes buffer (pH 7.4). Serotonin and fluoxetine were dissolved in 0.5% acetone. Final concentration 50 μM reserpine.

For experiments in which J2s were pre-treated with reserpine phosphate or CPA, the worms were pre-soaked in the drug solutions for 24 hours.

G. pallida Dispersal Assays

Dispersal assays were performed on 5 cm plates filled with 10 ml of 2% agarose. Serotonin, reserpine and fluoxetine were added to the agarose to give the desired final concentrations and the plates were dried for 2 days prior to the assays at room temperature. For the reserpine assays worms were pre-soaked in the compound for 18 h. On the day of the assay 100 μl of potato root diffusate (PRD), ddH2O or drug solvents were spread onto the plates and the plates were sealed with the parafilm. The grid with six equal concentric circles was placed under the assay plates and the centre was marked with a dot. Around 50-100 G. pallida J2s or C. elegans L2 s were pipetted with 5 μl of ddH2O onto the centre (origin), the plate was re-sealed and the total number of worms was counted as soon as the liquid had absorbed. The number of J2s in each concentric circle was counted after 1, 2 and 24 hours.

### Root Invasion Assays

J2s of G. pallida were first sterilised with 0.1% chlorhexidine digluconate, 0.5 mg/ml CTAB for 25 mins and washed three times with sterile 0.01% Tween-20. The J2s were then incubated with gentle agitation for 24 hours in water, 100 μM reserpine phosphate, 100 μM methiothepin, 100 μM CPA or 2 mM fluoxetine prior to inoculation of potato hairy root cultures with 25 J2s per infection point and 3 infection points per root system. Hairy root cultures were generated using Agrobacterium rhizogenes R1000 and multiplied. Individual root systems of equivalent size growing on 9 cm plates containing Murashige and Skoog basal medium (Duchefa, Suffolk, UK) with 2% sucrose were selected for inoculation. Nine to 11 replicate plates were used for each treatment or control. Roots were stained with acid fuchsin 13 days after infection and the number of nematodes in each root system counted. Each complete invasion assay was carried out on two separate occasions.

### Statistical Analysis

Data points in graphs are presented as the mean±standard error of the mean for the number of experiments as shown in individual figures. Data was plotted using Graph Pad 6 software (San Diego, Calif.). Statistical significance was determined either by unpaired Student's t-test, one-way or two-way ANOVA as appropriate; significance level set at P<0.05, followed by Bonferroni post-hoc tests as appropriate. Add curve fitting info

Table 1. Identification of C. elegans serotonin receptor homologues in G. pallida. G. pallida homologues of the four C. elegans genes encoding serotonin receptors were identified by reciprocal best BLAST hit analysis of the G. pallida predicted gene complement.

| | | | Closest G. pallida | |
|---|---|---|---|---|
| | Transcripts | Potential | match Amino acid | |
| C. elegans | in | orthologue in | identity (%) to | Protein |
| receptor | C. elegans | G. pallida | C. elegans | function |
| SER-1 | ser-1a | NO | 18.8 | G-protein |
| | ser-1b | | | coupled |
| | | | | serotonin |
| | | | | receptor |
| SER-4 | ser-4 | YES | 41.2 | G-protein |
| | | | | coupled |
| | | | | serotonin |
| | | | | receptor |
| SER-7 | ser-7a | YES | 35 | G-protein |
| | ser-7b | | | coupled |
| | ser-7c | | | serotonin |
| | | | | receptor |
| MOD-1 | mod-1a | YES | 56.8 | serotonin- |
| | mod-1b | | | gated |
| | mod-1c | | | chloride |
| | | | | channel |

### Example 2

The data presented in FIG. 14 suggest that G. pallida possess serotonin (5-hydroxytryptamine; 5-HT) receptors and suggest a role for endogenous serotonin in the regulation of stylet behaviour, as evidenced by stimulatory effects of the SSRI fluoxetine and the monoamine reuptake inhibitor imipramine. Fluoxetine inhibits the serotonin transporter and imipramine inhibits the monoamine transporter. Therefore, fluoxetine and imipramine prevent the reuptake of serotonin from the synaptic cleft and increase extrasynaptic serotonin levels. If they are acting in this capacity, this suggests that G. pallida J2s possess serotonin and that its signalling increases stylet activity. There is a wealth of evidence however, that shows the direct interaction of both fluoxetine and imipramine with several serotonin receptor subtypes, in the capacity of agonists and antagonists, for both mammalian and C. elegans receptors. There is also further evidence implying the interaction of SSRIs with non-serotonergic targets. It is therefore possible that the stimulatory effects of both fluoxetine and imipramine on stylet behaviour are due to interactions with serotonin receptors rather than inhibition of serotonin re-uptake.

Therefore, to investigate a physiological role for serotonin regulating stylet activity, the pharmacological agent reserpine was utilised. Reserpine acts by selectively blocking the activity of the vesicular monoamine transporter(s), thus preventing the loading of serotonin and other monoamines into vesicles and thereby preventing serotonergic and monoaminergic. If fluoxetine is indeed acting as an SSRI to induce stylet thrusting, then reserpine treatment will block the stimulatory effect of fluoxetine but not exogenous serotonin. The release of other monoamines, such as dopamine, octopamine and tyramine, should also be blocked by reserpine treatment. Dopamine, octopamine and tyramine however were tested for effects on stylet behaviour at concentrations up to 10 mM and had no effect on stylet behaviour (data not shown).

J2 G. pallida were soaked for 24 hours in different concentrations of reserpine and subsequently exposed to either 10 mM serotonin or 2 mM fluoxetine for 30 mins, at which point stylet thrusting was counted. Whilst reserpine had no effect on the stimulation of stylet activity by serotonin at any concentration, a concentration-dependent inhibition of fluoxetine-induced activity was seen, with a significant reduction seen at concentrations as low as 5 nM reserpine. 5 and 50 μM reserpine induced a near-complete block of the stimulatory effect of fluoxetine. As with methiothepin, reserpine also blocked the S-shaped posture and reduced movement that is typically induced by fluoxetine exposure. Reserpine had no independent stimulatory effect on stylet activity. In a separate experiment, G. pallida were soaked in 50 μM reserpine for differing lengths of time to assess the time course of reserpine activity. The reduction of fluoxetine-stimulated stylet activity was evident after 4 hours in reserpine and the full block was reached at 8 hours exposure. Subsequent to 24 hours soak in 50 μM reserpine a sample of juveniles were removed and soaked in water to assess the potential for recovery of the stylet response. Up to 22 hours post-reserpine treatment the juveniles were tested for fluoxetine-induced stylet thrusting yet no recovery of the response occurred, indicating a long-lasting block of serotonergic transmission by reserpine.

This confirms the activity of fluoxetine as an SSRI in G. pallida and that its stimulation of stylet behaviour is due to inhibition of serotonin re-uptake, thus validating a role for serotonin signalling in the control of stylet activity. This also provides evidence for the presence of the vesicular monoamine transporter in G. pallida. Indeed, an ortholog of cat-1, the C. elegans vesicular monoamine transporter, has been identified in the G. pallida genome.

1. A method of inhibiting or preventing damage to plants or seeds by a PPN (Plant Parasitic Nematode) the method comprising: applying an effective amount of a biogenic amine signalling pathway inhibitor to a plant or a seed.

2. The method of claim 1, wherein the biogenic amine signalling pathway inhibitor is a serotonin signalling pathway inhibitor.

3. The method according to claim 1 wherein the biogenic amine signalling pathway inhibitor is a compound or composition that inhibits or prevents stylet thrusting in the PPN.

4. The method according to claim 1, wherein the biogenic amine signalling pathway inhibitor is a compound or composition that prevents the PPN from piercing the root or a stem of a plant.

5. The method according to claim 1 wherein the PPN is selected from a sedentary endoparasite, a root knot nematode, a Meloidogyne spp nematode, a cyst nematode, a Globodera spp nematode a migratory ectoparasitic nematode, a stubby root nematode (Paratrichodorus or Trichodorus), a dagger nematode (Xiphinema), a needle nematode (Longidorus or Paralongidorus), a ring nematode (Criconemella or Macroposthhonia), a stunt nematode (Tylenchorhynchus or Merlinius), a pin nematode (Paratylenchus), and a spiral namatode (Helicotylenchus, Rotylenchus, and Scutellonema).

6. The method according to claim 1 wherein the biogenic amine signalling pathway inhibitor is any inhibitor of an enzyme required for serotonin signalling in one or more PPNs.

7. The method according to claim 1 wherein the biogenic amine signalling pathway inhibitor prevents or significantly reduces stylet thrusting in at least one PPN and prevents or significantly reduces the PPN's ability to pierce a plant with the stylet.

8. The method according to claim 1 wherein biogenic amine signalling pathway inhibitor is a modulator of the activity of the vesicular monoamine transporter (VMAT) or MOD-1 receptor.

9. The method of claim 8, wherein the VMAT is VMAT-2.

10. The method according to claim 1 wherein the biogenic amine signalling pathway inhibitor is reserpine or an active analogue or derivative thereof.

11. The method of claim 10 wherein reserpine or the active analogue or derivative thereof comprises a compound having the general structure 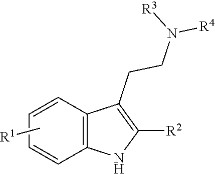
wherein
each of R¹ to R³ is independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl (such as phenyl); and
R⁴ comprises one or more groups selected from H, C₁₋₄ alkyl, OH, halogen, O(C₁₋₄ alkyl), C₂₋₄ alkenyl, OCO₂(C₁₋₄alkyl), NHCO₂(C₁₋₄alkyl), NHCO(C₁₋₄alkyl), O(C₁₋₄ alkyl), OC(O)C₁₋₄ alkyl, C(O)OC₁₋₄ alkyl, OC(O)C₆₋₁₀ aryl, C(O)OC₆₋₁₀ aryl, CH₂O(C₁₋₄ alkyl), and C₆₋₁₀ aryl.

12. The method according to claim 11, wherein reserpine or the active analogue or derivative thereof comprises a compound having the general structure 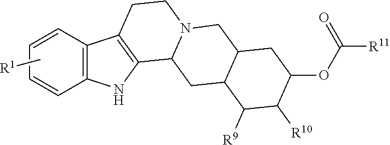
wherein each of R¹ and R⁹ to R¹¹ is independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl.

13. The method of claim 12, wherein reserpine or the active analogue or derivative thereof comprises a compound having the general structure 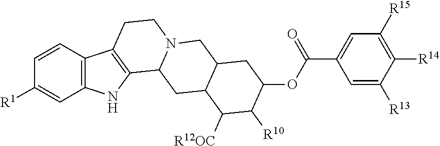
wherein each of R¹, R¹⁰, R¹³, R¹⁴ and R¹⁵ is independently selected from H, C₁₋₄ alkyl, C₂₋₄ alkenyl, OCO₂(C₁₋₄alkyl), NHCO₂(C₁₋₄alkyl), NHCO(C₁₋₄alkyl), OH, halogen, O(C₁₋₄ alkyl), OC(O)C₁₋₄ alkyl, C(O)OC₁₋₄ alkyl, CH₂O(C₁₋₄ alkyl), and C₆₋₁₀ aryl; and
R¹² is selected from C₁₋₄ alkyl, C₂₋₄ alkenyl, and C₆₋₁₀ aryl.

14. (canceled)

15. (canceled)

16. A seed coated with a composition comprising a biogenic amine signalling pathway inhibitor.

17. A plant or seed that is genetically modified to produce a biogenic amine signalling pathway inhibitor in one or more of its tissues.

18. The coated seed of claim 14 wherein the biogenic amine signalling pathway inhibitor is reserpine or an active analogue or derivative thereof.

19. The method according to claim 1, wherein the biogenic amine is serotonin, dopamine, octopamine and/or tyramine.

20. The coated seed according to claim 16, wherein the biogenic amine is serotonin, dopamine, octopamine and/or tyramine.

21. The plant or seed according to claim 17 wherein the biogenic amine signalling pathway inhibitor is reserpine or an active analogue or derivative thereof.

22. The plant or seed according to 17, wherein the biogenic amine is serotonin, dopamine, octopamine and/or tyramine.
